(19) United States
(12) Patent Application Publication
(10) Pub. No.: US 2024/0001447 A1
(43) Pub. Date: Jan. 4, 2024

(54) POWDER BED FUSION APPARATUS AND METHODS

(71) Applicant: RENISHAW PLC, Wotton-under-Edge, Gloucestershire (GB)

(72) Inventors: David Roberts MCMURTRY, Dursley (GB); Hugo George DERRICK, Stroud (GB); Nneji KEMAKOLAM, Ahrensburg (DE)

(73) Assignee: RENISHAW PLC, Wotton-under-Edge, Gloucestershire (GB)

(21) Appl. No.: 18/254,832

(22) PCT Filed: Nov. 30, 2021
(86) PCT No.: PCT/GB2021/053120

§ 371 Date: May 26, 2023

(30) Foreign Application Priority Data
Nov. 30, 2020 (GB) 2018817.3

(51) Int. Cl. B22F 12/33; B22F 12/49; B22F 12/00; B22F 12/70; B22F 10/28; B22F 10/73; B22F 10/68; B22F 10/32; B33Y 40/20; B33Y 30/00; B33Y 10/00

(52) U.S. Cl. CPC B22F 12/33; B22F 12/49; B22F 12/224; B22F 12/70; B22F 10/28; B22F 10/73; B22F 10/68; B22F 10/32; B33Y 40/20; B33Y 30/00; B33Y 10/00; B22F 2201/10; B22F 2998/10

(57) ABSTRACT

A powder bed fusion apparatus for building an object, including a processing chamber having a processing chamber aperture, scanner arranged to direct an energy beam to locations in a plane of the aperture and debuilding chamber having a debuilding chamber aperture. The apparatus includes a build chamber including a build sleeve and platform movable therein for supporting powder, the platform including a seal for engaging with the sleeve walls to prevent flow of powder past the platform; and at least one drive mechanism for driving movement of the platform. A translation mechanism moves the chamber between a building position, wherein the sleeve aligns with the processing aperture so an energy beam can be delivered to consolidate powder to build the object, and debuilding position, wherein the sleeve aligns with the debuilding aperture so the object and powder can be inserted into the debuilding chamber through movement of the platform.

### FIELD OF INVENTION

This invention concerns powder bed fusion apparatus and methods in which selected areas of a powder bed are solidified in a layer-by-layer manner to form a workpiece. The invention has particular, but not exclusive application, to selective laser melting (SLM) and selective laser sintering (SLS) apparatus.

### BACKGROUND

Powder bed fusion apparatus produce objects through layer-by-layer solidification of a material, such as a metal powder material, using a high energy beam, such as a laser or electron beam. A powder layer is formed in a working plane across a powder bed contained in a build sleeve by lowering a build platform to lower the powder bed, depositing a heap of powder adjacent to the lowered powder bed and spreading the heap of powder with a wiper across (from one side to another side of) the powder bed to form the layer. Portions of the powder layer corresponding to a cross-section of the workpiece to be formed are then solidified through irradiating these areas with the beam. The beam melts or sinters the powder to form a solidified layer. After selective solidification of a layer, the powder bed is lowered by a thickness of the newly solidified layer and a further layer of powder is spread over the surface and solidified, as required. An example of such a device is disclosed in U.S. Pat. No. 6,042,774.

A problem with such powder bed fusion apparatus is how to extract the workpiece from the powder bed after completion of the build. In particular, it is desirable to extract the workpiece and recover the unsolidified powder without exposing the unsolidified powder to an atmosphere having a high oxygen concentration, for example air, such that the recovered powder can be used for a subsequent build.

It is known to provide in-machine apparatus for removing powder from the built objects (debuilding) such that the powder can be returned to the machine without leaving the inert atmosphere formed therein. For example, EP1793979 discloses a glove box and suction nozzle to allow a user to separate the powder from the workpiece before the workpiece is removed from the powder bed fusion apparatus. WO2018/154283 discloses a mechanical manipulator for rotating the object above the working plane to remove powder form the object. DE102012002855 A1 discloses a carriage for receiving and/or transporting a building module. The carriage comprises a glove box having connections for connecting the glove box to a supply of protective gas. EP3263316 A discloses apparatus comprising an unpacking station that is configured to facilitate unpacking of the one or more 3D objects from pre-transformed material. A build module reversibly engages with the processing chamber. The 3D object may be removed from the build module to an unpacking station.

In all of these machines, during removal of powder from the object, the apparatus for building the object (laser, scanners, etc) are not being used. This is undesirable because this apparatus represents a significant capital cost of the machine and therefore, users want to minimise the periods during which the apparatus is not in use.

DE102004057866 A1 and DE102007018601 disclose a machine comprising a horizontally movable build chambers, wherein, at the end of a build, a build chamber containing the part and powder bed is moved from a first housing section to a second housing section, in which the part is separated from the powder. A further build chamber may be moved to the first housing section such that a further build can be commenced. A protective gas atmosphere may be maintained in both the first and second housing sections. The second housing section may comprise a removal airlock.

WO2019/211476 A1 discloses a machine comprising a process chamber enclosing a process space and an unpacking chamber enclosing an unpacking space. A transporting device serves to convey, simultaneously, a first building cylinder from an operating position in the process space into an unpacking position in the unpacking space and second building cylinders from the unpacking position to the operating position. The transporting device includes a seal and a lateral guide operatively connected to the seal, which together ensure that the building space, the process space and the unpacking space are sealed. This may prevent material powder or protective gas from escaping to the outside or air from entering the building spaces from the outside.

Such solutions are undesirable because two build chambers, comprising a build sleeve and z-axis drive mechanisms have to be provided adding cost, increasing the footprint of the machine and increasing complexity and therefore unreliability. In DE102004057866 A1, two debuilding stations (second housing sections) have to be provided, one for each build chamber, to allow powder removal from the built objects within an inert atmosphere. DE102007018601 discloses a sliding guide on which the handling area and the scanner unit can be moved (linearly or by rotation) above the building chambers. However, movement of the scanner relative to the working plane in which powder layers are spread requires very accurate positioning of the scanner when it is moved between positions to ensure that the scanning plane is aligned with the working plane.

Of the machines discussed above, only WO2018/154283 discloses a mechanism for automating powder removal within the machine. The height of the object is limited to one that can be rotated in the space between the working plane and the ceiling of the processing chamber.

### SUMMARY OF INVENTION

According to a first aspect of the invention there is provided a powder bed fusion apparatus for building an object in a layer-by-layer manner, the powder bed fusion apparatus comprising a processing chamber having a processing chamber aperture; a scanner arranged to direct an energy beam to locations in a plane of the processing chamber aperture; a debuilding chamber having a debuilding chamber aperture; a build chamber defined by a build sleeve and a build platform movable within the build sleeve for supporting powder within the build sleeve, the build platform comprising a build platform seal for engaging with walls of the build sleeve to prevent the flow of powder past the build platform; at least one drive mechanism for driving movement of the build platform in the build sleeve; and a translation mechanism for moving the build chamber between a building position, in which the build sleeve aligns with the processing chamber aperture such that an energy beam can be delivered by the scanner to the processing chamber aperture to consolidate powder supported by the build platform in the build sleeve to build the object, and a debuilding position, in which the build sleeve aligns with the debuilding chamber aperture such that the object and powder can be inserted into the debuilding chamber through the debuilding chamber aperture through movement of the build platform within the build sleeve.

The translation mechanism may be arranged to move the build chamber from the debuilding position to the building position whilst the object is in the debuilding chamber. The translation mechanism may be arranged to move the build chamber from the debuilding position to the building position whilst the object and unconsolidated powder are in the debuilding chamber. The translation mechanism may be arranged to move the build chamber from the debuilding position to the building position whilst a debuilding process is being carried out in the debuilding chamber.

The powder bed fusion apparatus may comprise a closure member arranged to close the debuilding chamber aperture to powder flow. The closure member may be arranged to close the debuilding chamber aperture to prevent powder flow back into the build chamber and/or into a space vacated by the build chamber when the build sleeve moves from the debuilding position. Additionally, the closure member may be arranged to close the debuilding chamber aperture to prevent gas, such as air, from passing from the debuilding chamber into the build chamber and/or into a space vacated by the build chamber when the build sleeve moves from the debuilding position. In other words, the closure member may close the debuilding chamber aperture in an airtight or hermitic manner.

In this way, the object and powder can be inserted into the debuilding chamber in order to carry out a debuilding process in which the object is separated from the powder and the build sleeve returned to the processing chamber to begin the next build before the debuilding process has been completed. The closure member ensures that the powder separated from the object during the debuilding process is retained in the debuilding chamber upon the return of the build chamber to the building position. Furthermore, the processing chamber can be designed in a manner optimal for consolidation of powder without compromise for the removal of the object through the processing chamber.

It will be understood that the term “debuilding” as used herein means separating the object from unconsolidated powder of the powder bed formed during the build. A debuilding chamber is a chamber in which such a process takes place. The debuilding process may be carried out in the debuilding chamber manually, for example, using a glove box and, optionally, a vacuum device; automatically, for example using a rotating device, such as disclosed in WO2018/154283, which is incorporated herein in its entirety by reference, vibration devices, impact devices and/or a set of gas blowers and gas suckers; or using a combination of manual and automated operations.

It is known to build an object on a build substrate, for example as described in U.S. Pat. No. 5,753,274. It is also known that the build substate can be placed on a build platform without being secured thereto with bolts and the like. For example, WO2015/092442 discloses a kinematic mounting for positioning the build substrate on the build platform in a repeatable position. The build typically results in the object being attached to the build substrate either directly or via additively built anchors/supports. The build substrate may be arranged to form the build platform when mounted in the build sleeve, the build substate comprising the build platform seals that engage the walls of the build sleeve, or the build platform may be separate from the build substrate, wherein the build substrate is removably mounted on the build platform (in which case the build substrate may not comprise build platform seals as the flow of powder is already prevented via the separate build platform).

The apparatus may be arranged such that the build substrate with the object attached thereto can be removed from the build sleeve when the object and powder are inserted into the debuilding chamber. The apparatus may comprise a retaining mechanism within the debuilding chamber arranged to receive the build substrate when the build substrate is inserted into the debuilding chamber and retain the build substrate in the debuilding chamber upon retraction of the drive mechanism. The retaining mechanism for retaining the build substrate is arranged to keep the build substrate and object clear of the debuilding chamber aperture such that the closure member is able to move to close the debuilding chamber aperture. The retaining mechanism may be arranged for rotating the object to remove powder, for example like the mechanical mechanism disclosed in WO2018/154283. The retaining mechanism may comprise at least one arm to be secured to the object and/or build substrate, the at least arm movable to move the object and build substrate away from the debuilding chamber aperture.

The powder bed fusion apparatus may comprise a build substrate loader arranged to load a build substrate into the build sleeve after removal of the previous build substrate from the build sleeve. The build substrate loader may be arranged to load the build substrate into the build sleeve when the build sleeve is located in the debuilding position. The build substrate loader may be arranged to load the build substrate into the build sleeve after the closure member has closed the debuilding chamber aperture. For example, the build substrate may be carried by the closure member such that closure of the debuilding chamber aperture with the closure member aligns the build substrate with the build sleeve in the debuilding position such that the build sleeve can receive the build substrate. Alternatively, the build substrate loader may be arranged to load the build substrate into the build sleeve at a build substrate loading position to which the build chamber can be moved by the translation mechanism, the build substrate loading position being different to the building position and debuilding position. It is desirable that the build substrate can be loaded into the build sleeve whilst powder that falls away from the object into the debuilding chamber is retained in the debuilding chamber. Accordingly, it is desirable that the closure member is in place or being put in place on loading of the build substrate into the build sleeve.

The build substrate loader may comprise a loading chamber having an external door for introducing a build substrate into the loading chamber and an internal door for allowing the build substrate to be loaded into the build sleeve. A purging device may be provided for purging the loading chamber of air after a build substrate has been placed into the loading chamber and the external door has been closed and before the internal door is opened. The purging device may comprise an inert gas inlet to the loading chamber connected to a source of pressurised inert gas, such as argon or nitrogen, for introducing the inert gas into the loading chamber. The purging device may comprise a vent for venting air pushed from the loading chamber by the pressurised inert gas. The term “pressurised” as used herein means that the gas is above atmospheric pressure.

A closure mechanism may comprise a powder removal element for removing powder from an upper surface of the build platform as the closure member moves over the build platform. A closure mechanism may be arranged to move the closure member from a position spaced from the debuilding chamber aperture such that the object and powder can be inserted into the debuilding chamber through the debuilding chamber aperture to a position closing the debuilding chamber aperture. In one embodiment, the powder removal element is a wiper or brush attached to a lower surface or edge of the closure member or attached to the closure mechanism, the wiper or brush arranged to engage with the upper surface of the build platform to sweep powder from the upper surface. In another embodiment, the powder removal element is a gas nozzle for delivering a jet of gas onto the upper surface to blow the powder from the upper surface.

The closure member may comprise upper sloping surfaces extending downwards from a central apex to a periphery of the closure member. In this way, powder released from the object that falls onto the upper sloping surfaces is urged towards the periphery of the closure member by gravity. The closure member may comprise a vibrator for vibrating surfaces of the closure member to induce powder movement across the surfaces.

The debuilding chamber may comprise at least one powder collection channel located adjacent the debuilding chamber aperture for collecting powder released from the object. The sloping surface of the closure member may be arranged to deliver powder into the at least one powder collection channel.

The apparatus may comprise a closure seal for sealing a gap between a debuilding chamber wall and the closure member when the closure member is in a position closing the debuilding chamber aperture. The closure seal may comprise an inflatable seal, which upon inflation seals the gap between the debuilding chamber wall and the closure member. The apparatus may be arranged to inflate the inflatable closure seal after the closure member has been positioned to close the debuilding chamber aperture. The closure mechanism may comprise a clamping mechanism to clamp the closure member in place in the debuilding chamber aperture. The clamping mechanism may be arranged to apply a force to compress the closure seal. The closure member may comprise a planar mating surface that engages with a corresponding planar mating surface of the debuilding chamber around the debuilding chamber aperture to close the debuilding chamber aperture, wherein the clamping mechanism applies the force transverse to the planar mating surfaces. The planar mating surface of the closure member may comprise sealing material that is compressed under the force of the clamp. The clamping mechanism may be located in the debuilding chamber when the closure member closes the debuilding chamber aperture. In this way, maintenance of the clamping mechanism can be carried out through an access door in the debuilding chamber used to remove the object.

The apparatus may comprise a controller for controlling raising and lowering of the build platform.

The controller may also control activation of the closure mechanism such that the closure member closes the debuilding chamber aperture with an unused (replacement) build substrate on the build platform. The controller may activate the closure mechanism to close the debuilding chamber aperture with the closure member when the unused build substrate is substantially flush with a plane of the closure member when closing the debuilding chamber aperture. This minimises the volume of atmosphere trapped between the build platform/build substrate and the closure member. Accordingly, if the debuilding chamber contains an atmosphere including oxygen, such as air, any of this atmosphere that is trapped in the build chamber when it is translated back to the build position is minimised. Any oxygen that is trapped within this region may be gettered before the build commences by scanning one or more lasers over the unused build substrate before the build commences such that the oxygen is incorporated within melted material of the build substrate. It will be understood that “unused build substrate” includes build substrates that have been used for a previous build but have been reconditioned, such as machined, such that the build substrate can be reused for a further build.

The build sleeve may be arranged such that, in the building position, the build sleeve engages the processing chamber to surround the processing chamber aperture and, in the debuilding position, the build sleeve engages with the debuilding chamber to surround the debuilding chamber aperture.

The translation mechanism may be arranged to displace the build chamber relative to the processing chamber and the debuilding chamber in a lateral direction to a reciprocating direction of the build platform in the build sleeve. The translation mechanism and/or the build sleeve may be arranged such that, as the build chamber reaches the building position, at least a portion of the build sleeve is arranged to be displaced perpendicularly to the lateral direction to engage with a processing chamber wall. In this way, during the lateral movement the build sleeve is clear of build chamber wall, whereas a seal is formed on arriving at the building position. The translation mechanism and/or the build sleeve may be arranged such that, as the build chamber reaches the debuilding position, at least a portion of the build sleeve is arranged to be displaced perpendicularly to the lateral direction to engage with a debuilding chamber wall. In this way, during the lateral movement the build sleeve is clear of debuilding chamber wall, whereas a seal is formed on arriving at the debuilding position. The translation mechanism may be arranged, as the build chamber reaches the build/debuilding position, to displace the build chamber perpendicularly to the lateral direction to engage with the processing/debuilding chamber wall. The build sleeve may comprise a sealing part extending around an opening of the build sleeve, at least the sealing part arranged to be displaced perpendicularly to the lateral direction to engage with the processing/debuilding chamber wall as the build chamber reaches the build/debuilding position.

The translation mechanism may be arranged to displace the build chamber such that the build chamber undergoes a rotation.

The build chamber may comprise a biasing member biasing at least the sealing part of the build sleeve towards the processing chamber and one or more followers arranged to follow a surface of the processing and/or debuilding chamber wall, the surface of the processing and/or debuilding chamber wall having a corresponding detent therein for each of the one or more followers, wherein, in the build/debuilding position, each follower is received in the corresponding detent such that the sealing part is biased to engage the processing/debuilding chamber wall by the biasing member. The one or more followers are arranged to space the sealing part from the processing and/or debuilding chamber wall when not received in the corresponding detent. Such an arrangement avoids the need for additional actuators to achieve the movement perpendicular to the lateral direction.

The drive mechanism may move with the build chamber from the building position to the debuilding position. In this way, the same drive mechanism may be used to move the build platform in the build sleeve during the build of the object and move the build platform in the build sleeve to insert the object and powder into the debuilding chamber. Alternatively, the drive mechanism may be arranged to decouple from the build platform when the build chamber is translated from the building position to the debuilding position. For example, the apparatus may comprise two drive mechanisms, one for moving the build platform in the build sleeve when the build chamber is in the building position and another for moving the build platform in the build sleeve when the build chamber is in the debuilding position. An alternative would be to locate the debuilding chamber below the build sleeve, such that the object and powder can be lowered, for example under gravity, into the debuilding chamber together with the build platform. Such an alternative may not require a drive mechanism to move the build platform in the build sleeve in the debuilding position. In a further alternative, the debuilding chamber may be lowered over the object and the powder as the build sleeve is lowered around the build platform when the build chamber is in the debuilding position. Again, in this further alternative, the lowering of the debuilding chamber and build sleeve may be carried out with or without a drive mechanism.

The translation mechanism may comprise at least one motion guide, such as guide rail, along which either the build chamber travels, or the processing chamber and debuilding chamber travel. The motion guide may be a linear motion guide enabling linear travel of the build chamber, or the processing chamber and debuilding chamber.

The apparatus may comprise a dividing plate that forms a processing chamber wall that defines the processing chamber aperture and a debuilding chamber wall that defines the debuilding chamber aperture. The translation mechanism may be attached to the dividing plate. The motion guide, such as one or more guide rails, of the translation mechanism may be attached to the dividing plate. The motion guide may be attached to a lower surface of the dividing plate and the build chamber may comprise guides that travel along the motion guide to move the build chamber between the building position and the debuilding position.

The apparatus may comprise a layer formation device for forming layers of powder in a working plane across a build volume delimited by the build chamber when the build chamber is engaged with the processing chamber. The layer formation device may comprise a powder dispenser arranged to dispense powder into the processing chamber. The layer formation device may comprise a recoater movable within the processing chamber for spreading powder dispensed by the powder dispenser across the working plane. The layer formation device and powder hopper may be as described in PCT/GB2020/051042, which is incorporated in its entirety by reference, but with the powder recovered from the debuilding chamber rather than directly from the processing chamber.

The apparatus may comprise a gas circuit for forming an inert atmosphere in the processing chamber. The apparatus may comprise an external door in the debuilding chamber for the exit of the object and a hermetic closure for sealing an aperture between the external door and the processing chamber or an inert gas trap for preventing the flow of air from the external door to the processing chamber. The hermetic closure may seal the processing chamber aperture or the debuilding chamber aperture. In the case of the latter, the apparatus may be arranged to maintain an inert atmosphere in the processing chamber and a transfer chamber in which the build chamber travels between the building position and the debuilding position. In this way, as well as acting as a debuilding station the debuilding chamber may also act as an airlock. The transfer chamber may be located below the processing chamber and gaseously linked to the processing chamber via the processing chamber aperture and be located below the debuilding chamber and gaseously linked to the debuilding chamber via the debuilding chamber aperture. In this way, the combination of the processing chamber, debuilding chamber and transfer chamber act as a inert gas trap (or U-bend) with air prevented from travelling to the processing chamber from an external door to the debuilding chamber via heavier inert gas, such as argon gas, in the transfer chamber. Accordingly, an inert gas is maintained in the processing chamber during delivery of a built object to the debuilding station and extraction of the object from the debuilding station.

The build chamber may be movable between the building position to the debuilding position with an open upper end, i.e. the upper end is not closed by a further closure member when the build chamber is moved by the translation mechanism. Closing of the build chamber during translation between the building and debuilding positions may not be necessary because the build chamber is translated within the inert atmosphere in the translation chamber.

The hermetic closure may comprise the closure member. The hermetic closure may comprise a hermetic seal on the closure member or may be arranged to be engaged by the closure member when closing the debuilding aperture. The hermetic seal may comprise an inflatable seal.

The layer formation device may be connected with a powder hopper for supplying the layer formation device with powder. The apparatus may comprise a powder conveyor for conveying powder recovered from the debuilding chamber to the layer formation device. The powder conveyor may convey recovered powder from the debuilding chamber to the powder hopper. The powder conveyor may convey recovered powder from the powder collection channels of the debuilding chamber to the layer formation device/powder hopper. The powder conveyor may pneumatically convey the recovered powder. The powder conveyor may comprise a filtering device arranged to filter the recovered powder before delivery to the layer formation device/powder hopper. The filtering device may filter the recovered powder to remove particles having a size and/or mass above and/or below predetermined threshold(s). The filtering device may comprise a sieve and/or a cyclone separator. The powder conveyor may be as described in PCT/GB2020/051044, which is incorporated in its entirety by reference, but with the powder recovered from the debuilding chamber rather than directly from the processing chamber.

The apparatus may comprise a further hopper, (a “total loss” powder hopper) and the powder conveyor may be capable of delivering the recovered powder to the further hopper. The further hopper may be on a spur line of the powder conveyor off the main line that leads to the layer formation device. The powder conveyor may comprise a diverter valve, the diverter valve configured to selectively place the recovered powder in fluid communication with either the layer formation device or the further hopper. The diverter valve may be as described in PCT/GB2020/051044, which is incorporated in its entirety by reference, but with the powder recovered from the debuilding chamber rather than directly from the processing chamber.

The scanner may be housed within the processing chamber. Alternatively, the scanner may be mounted externally of the processing chamber and the processing chamber has an aperture for allowing the energy beam to be directed into the processing chamber by the scanner. The aperture may be closed by a window transparent to the energy beam.

It will be understood that the movements described herein are movements of one component relative to a corresponding component and to achieve this movement either one or both components may move relative to a fixed frame or base of the apparatus. For example, the build platform may be arranged to move within a fixed build sleeve, the build sleeve arranged to move relative to the fixed build platform or both may move relative to each other and the fixed frame or base of the powder bed fusion apparatus. Furthermore, the translation mechanism may move the build chamber relative to a fixed processing chamber and fixed debuilding chamber, may move the processing chamber and debuilding chamber relative to a fixed build chamber or may move all of the processing chamber, debuilding chamber and build chamber relative to each other and the fixed frame or base of the powder bed fusion apparatus.

According to a second aspect of the invention there is provided a powder bed fusion method for building an object in a layer-by-layer manner, the powder bed fusion method comprising:—i) building an object in a build chamber, the build chamber defined by a build sleeve and a build platform movable within the build sleeve for supporting powder within the build sleeve, the build platform comprising a build platform seal for engaging with walls of the build sleeve to prevent the flow of powder past the build platform, wherein, the object is built with the build sleeve aligned with a processing chamber aperture of a processing chamber by directing an energy beam to selected locations within the processing chamber aperture to consolidate powder in the build chamber; ii) after completion of the build, moving the build chamber to align the build sleeve with a debuilding chamber aperture in a debuilding chamber and inserting the object and powder into the debuilding chamber from the build sleeve through the debuilding chamber aperture; and iii) disengaging the build sleeve from the debuilding chamber before or whilst separating powder from the object in the debuilding chamber.

The method may comprise closing the debuilding chamber aperture to powder flow with a closure member before or during disengagement of the build sleeve from the debuilding chamber.

The method may comprise repeating steps (i) through (iii). The method may include separating the object from the powder in the debuilding chamber, at least in part, simultaneously with step (i). In this way, steps for the next build can commence before the debuilding process for the previous object has been completed.

The method may comprise forming an inert atmosphere in the debuilding chamber. The method may comprise separating the object from unconsolidated powder of the powder bed within the inert atmosphere in the debuilding chamber. The method may comprise inserting the object and powder into the debuilding chamber when the debuilding chamber contains an inert atmosphere.

The method may comprise removing the object from the debuilding chamber after a debuilding process, for example through an external door. The method may comprise hermetically sealing the debuilding chamber aperture, for example with a closure member, when the object is removed from the debuilding chamber. In this way, an inert atmosphere is maintained in the processing chamber, the build chamber and/or in a transfer chamber in which the build chamber travels between the processing chamber and the debuilding chamber with the debuilding chamber acting as an airlock.

The method may comprise loading a further build substrate into the build sleeve. The method may comprise loading the further build substrate into the build sleeve during debuilding of the object in the debuilding chamber. The method may comprise loading the further build substrate into the build sleeve after the debuilding chamber aperture has been closed using a closure member. The method may comprise loading the further build substrate into the build sleeve together with closing the debuilding chamber aperture with the closure member.

The method may comprise conveying the unconsolidated powder, separated from the object in the debuilding chamber, from the debuilding chamber to a powder dispenser for dispensing powder into the processing chamber. The method may comprise conveying the unconsolidated powder in an inert atmosphere.

The method may comprise closing the debuilding chamber aperture with the closure member with an unused (replacement) build substrate on the build platform. The method may comprise closing the debuilding chamber aperture with the closure member when the unused build substrate is substantially flush with a plane of the closure member when closing the debuilding chamber aperture.

According to a third aspect of the invention there is provided apparatus for, at least partially, debuilding an object built in a layer-by-layer manner in a powder bed fusion process, the apparatus comprising a chamber having a chamber aperture, the chamber engaged or engageable with a build chamber of a powder bed fusion apparatus such that the build chamber surrounds the chamber aperture and a build substrate and object attached thereto can be inserted into the chamber from the build chamber through the chamber aperture by a drive mechanism, a retaining mechanism comprising retaining formations for engaging with the build substrate with an object attached thereto to retain the build substrate and object upon retraction of the drive mechanism, wherein the retaining formations can be activated to release the build substrate through engagement of the retaining formations with a build substrate carrier during movement of the carrier such that the build substrate with object attached is loaded onto the build substrate carrier for removal from the chamber.

In this way, release of the build substrate from the retaining mechanism is automated. As release of the retaining formations is caused by engagement with the build substrate carrier, there is no need to activate a motor separate from a motor that drives the build substrate carrier to achieve the release. The build substrate carrier may be a part of the apparatus or may be part of another apparatus, such as a conveying mechanism. For example, the apparatus of the third aspect of the invention could be used with conveying apparatus provided by a third party.

The apparatus may be a powder bed fusion apparatus. The chamber may be a debuilding chamber as described above in accordance with the first and second aspects of the invention or may be a processing chamber where the object is built in a layer-by-layer manner (through which the lasers pass to consolidate material of the powder bed). Alternatively, the apparatus may be debuilding apparatus separate from the powder fusion apparatus. For example, the build chamber may be removable from the powder bed fusion apparatus such that it can be transported to the debuilding apparatus.

The retaining formation may comprise at least one clip biased to extend into a slot or below a flange on the build substrate and shaped such that initial engagement of the clip with the build substrate pushes the clip against the biasing until the clip can extend into the slot or below the flange. The retaining mechanism may comprise a movable arm associated with the or each clip, a pair of clips or more than two clips, the arm engageable by the build substrate carrier to move the clip(s) out from the slot or from beneath the flange such that the build substrate is released from the retaining mechanism. The or each arm may be arranged to push the clips(s) against the biasing. The arm may be a lever acting as a force multiplier such that a smaller force applied to the arm by the build substrate carrier is transformed into a larger force applied to the clip(s).

According to a fourth aspect of the invention there is provided a powder fusion apparatus for building an object in a layer-by-layer manner, the powder bed fusion apparatus comprising a build chamber defined by a build sleeve and a build platform movable within the build sleeve for supporting powder within the build sleeve, the build platform comprising a build platform seal for engaging with walls of the build sleeve to prevent the flow of powder past the build platform; at least one drive mechanism for driving movement of the build platform in the build sleeve; and a controller for controlling the drive mechanism, wherein the controller is arranged to, after removal of an object from the build platform and before commencing the next build, cause the drive mechanism to repeatedly drive the build platform up and down to free powder from a surface of the build platform.

The controller may be further arranged to control a recoater or wiper to move across the build platform after the build platform has been repeatedly driven up and down to wipe freed powder from the build platform.

According to a fifth aspect of the invention there is provided a powder bed fusion method for building an object in a layer-by-layer manner, the powder bed fusion method comprising:—i) building an object in a build chamber, the build chamber defined by a build sleeve and a build platform movable within the build sleeve for supporting powder within the build sleeve, the build platform comprising a build platform seal for engaging with walls of the build sleeve to prevent the flow of powder past the build platform; at the end of a build of the object, removing the object from the build platform; repeatedly driving the build platform up and down to free powder from a surface of the build platform; wiping the freed powder from the surface; and, after the wiping of the surface, commencing the next build.

### DESCRIPTION OF THE DRAWINGS

FIGS. 1a to 1d illustrate a powder bed fusion apparatus according to a first embodiment of the invention in various configurations during a manufacturing process;

FIGS. 2a to 2e illustrate a translation mechanism of the powder bed fusion apparatus shown in FIGS. 1a to 1d for displacing the build chamber between the building position and the debuilding position;

FIGS. 3a to 3c illustrate a powder bed fusion apparatus according to a second embodiment of the invention in various configurations during a manufacturing process;

FIGS. 4a to 4d illustrate a powder bed fusion apparatus according to a third embodiment of the invention in various configurations during a manufacturing process;

FIG. 5 is a perspective view of a closure element according to one embodiment of the invention;

FIGS. 6a to 6j illustrate apparatus and a corresponding operation that can be used in a debuilding chamber of a powder bed fusion apparatus according to an embodiment of the invention;

FIGS. 7a to 7f illustrate apparatus and a corresponding operation that can be used in a debuilding chamber of a powder bed fusion apparatus according to another embodiment of the invention;

FIG. 8 illustrates a powder bed fusion apparatus according to a fourth embodiment of the invention

FIG. 9 is a perspective view of a retaining mechanism of a powder bed fusion apparatus according to a fifth embodiment of the invention;

FIG. 10 is a cross-sectional view of the retaining mechanism shown in FIG. 9;

FIG. 11 is a perspective view of further elements of the powder bed fusion apparatus according to a fifth embodiment of the invention;

FIG. 12 is a perspective view of the further elements shown in FIG. 11 from a different viewpoint; and

FIG. 13 is a cross-sectional view of the further elements shown in FIGS. 11 and 12.

### DESCRIPTION OF EMBODIMENTS

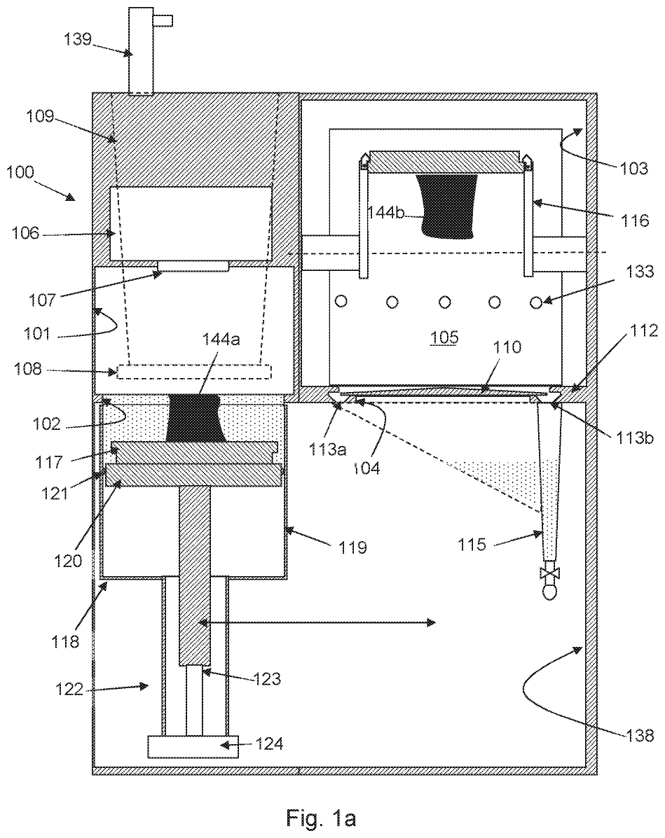

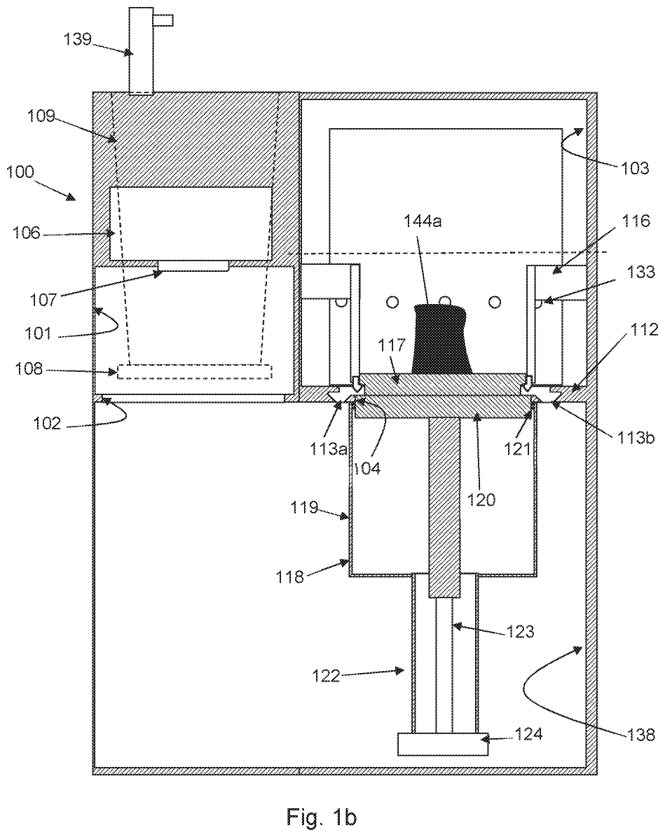

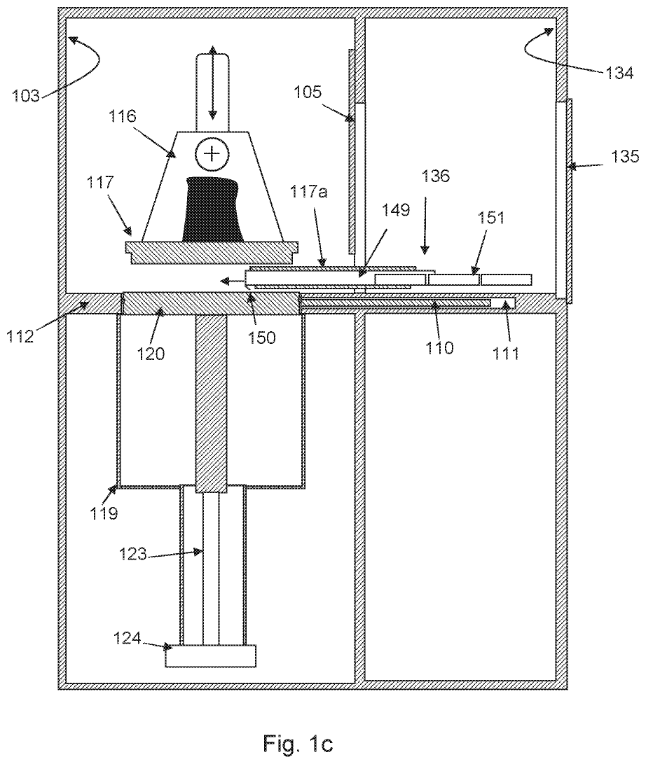

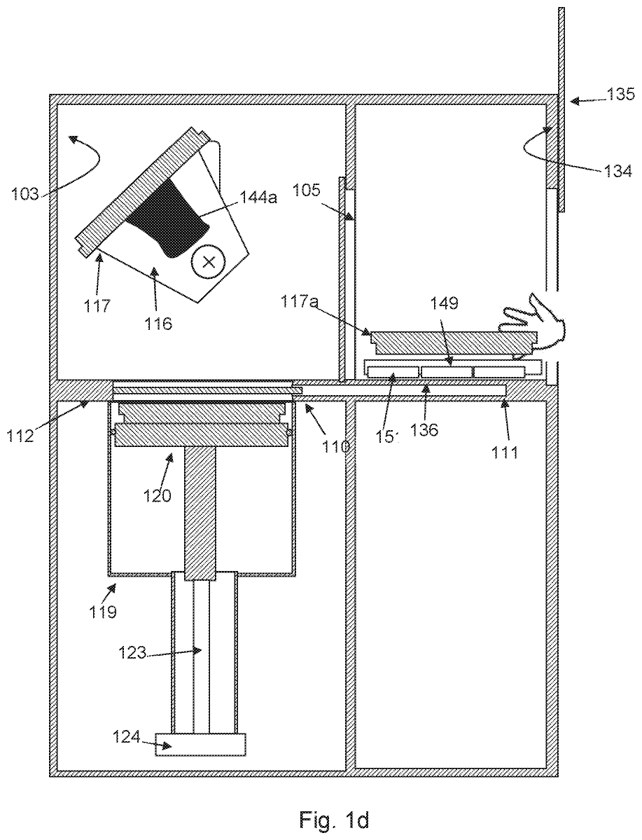

Referring to FIGS. 1a to 1d, a powder bed fusion apparatus 100 for building an object in a layer-by-layer manner comprises a processing chamber 101 having a processing chamber aperture 102. A scanner 106 is mounted above the processing chamber 1010 and arranged to direct a laser beam generated by a laser (not shown) to locations in a plane of the processing chamber aperture 102 through a processing chamber window 107 in the processing chamber 101. A powder dispenser 108 dispenses powder into the processing chamber 101 from a powder hopper 109. The powder is spread in a working plane across the processing chamber aperture 102 using a powder recoater, such as a wiper (not shown). The powder hopper, powder dispenser and recoater may be as described in WO2010/007396 and WO2020/221996, which are incorporated herein in their entirety by reference.

The powder bed fusion apparatus further comprises a debuilding chamber 103 having a debuilding chamber aperture 104 and an exit aperture closed by a door 105. A closure member 110 is provided to close the debuilding chamber aperture 104 to powder flow. In this embodiment, the closure member 110 is arranged to move in a slot 111 in a processing plate 112, which defines a floor of the debuilding chamber 104. Either side of the debuilding chamber aperture 104 are powder collection channels 113a, 113b, which lead to a powder collection hopper 115. Powder in powder collection hopper 115 is transported back to powder hopper 109. For example, the powder may be transported back to powder hopper 109 using a powder transport as disclosed in WO2019/081894 and WO2020/221998, which are incorporated herein in their entirety by reference.

As shown FIG. 1, the closure member 110 is dimensioned such that the closure member 110 terminates over the powder collection channels 113a, 113b. The closure member 110 has a sloping upper surface to encourage the flow of powder from a middle of the closure member 110 to the edges over the powder collection channels 113a, 113b. Within the closure member 110 are vibrators for vibrating the surface of the closure member 110 to encourage powder to move along the upper surface.

Within the debuilding chamber 104 is a retaining mechanism 116 arranged to receive a build substrate 117 when the build substrate 117 is inserted into the debuilding chamber 104 and retain the build substrate 117 in the debuilding chamber 104 upon retraction of the build platform 120 and/or a drive mechanism 122 that pushes the build substrate into the debuilding chamber 104 (as described in more detail below). The retaining device 116 for retaining the build substrate 117/117a is arranged to keep the build substrate 117/117a and object 144a/144b clear of the debuilding chamber aperture 104 such that the closure member 110 is able to move to close the debuilding chamber aperture 104. The retaining mechanism 116 comprises at least one arm, in this embodiment two arms, to be secured to the build substrate 117/117a, the at least arm movable to move the object 144a/144b and build substrate 117/117a, for example with linear movement, away from the debuilding chamber aperture 104. The retaining mechanism 116 may also manipulate the build substrate 117/117a and object 144a/144b attached thereto to remove powder from the object. For example, the retaining mechanism 116 may be a mechanical mechanism for rotating the object about one or more axes A to remove the powder, such as disclosed in WO2018/154283.

The debuilding chamber 104 may also comprise gas inlets 133 for generating a jet of inert gas to aid the removal of powder from the object 144a/144b.

The processing chamber 101 and the debuilding chamber 103 are linked by a volume enclosed by a transfer chamber 138. The transfer chamber 138 is arranged such that an inert gas atmosphere can be formed therein.

The powder bed fusion apparatus further comprises a build chamber 118 defined by a build sleeve 119 and a build platform 120 movable within the build sleeve 119 for supporting powder within the build sleeve 119. The build platform 120 comprises a build platform seal 121 for engaging with walls of the build sleeve 119 to prevent the flow of powder past the build platform 120. A drive mechanism 122 is provided for driving movement of the build platform 120 in the build sleeve 119. In this embodiment the drive mechanism 119 comprises a drive shaft 123, in this embodiment in the form of a lead screw, and a motor 124 for driving the drive shaft. The build platform 120 comprises mounting formations (not shown) for engaging with mounting formation of a build substrate 117. For example, the mounting formations may be kinematic or pseudo kinematic mounting formations as described in WO2015/092442, which is incorporated herein in its entirety by reference.

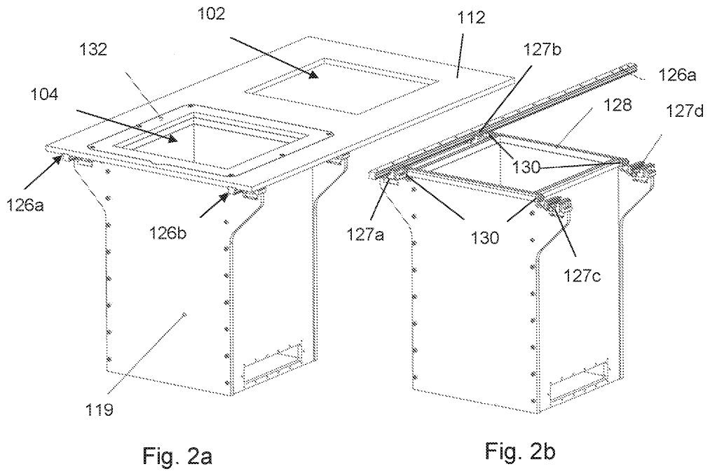

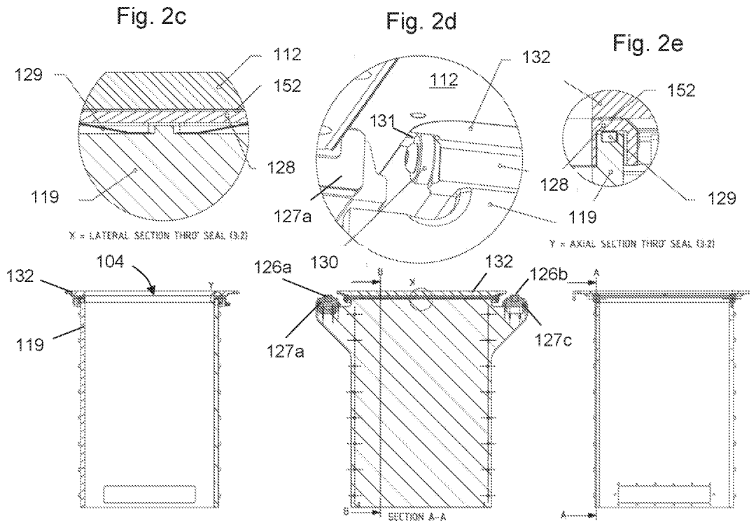

The powder bed fusion apparatus further comprises a translation mechanism (shown in FIGS. 2a to 2e) for moving the build chamber 118 between a building position (shown in FIG. 1a), in which the build sleeve 119 aligns with the processing chamber aperture 102 such that the laser beam can be delivered by the scanner 106 to the processing chamber aperture 102 to consolidate powder supported by the build platform 118 in the build sleeve 119 to build the object, and a debuilding position (shown in FIGS. 1b, 1c and 1d), in which the build sleeve 119 aligns with the debuilding chamber aperture 104 such that the object and powder can be inserted into the debuilding chamber 103 through the debuilding chamber aperture 104 through movement of the build platform 120 within the build sleeve 119. The build chamber 118 is movable within the volume enclosed by the transfer chamber 138.

The translation mechanism 125 is shown in more detail in FIGS. 2a to 2e. The processing plate 112 defines the floor of both the processing chamber 101 and the debuilding chamber 103 and has two apertures therein that form the processing chamber aperture 102 and the debuilding chamber aperture 104, respectively. A pair of linear guide rails 126a, 126b are attached to the underneath of the processing plate 112. Carriages 127a, 127b, 127c and 127d attached to the build sleeve 119 engage with the guide rails 126a, 126b such that the build chamber 118 can move between the building position and the debuilding position as guided by the guide rails 126a, 126b. A motor and drive mechanism (not shown) is provided for moving the build chamber 118 along the rails 126a, 126b.

The build sleeve 119 comprises an upper sealing part 128 extending around an opening of the build sleeve 119. The sealing part 128 is arranged to be displaced perpendicularly to the lateral direction to engage with the processing plate 112 as the build chamber 118 reaches the build/debuilding position. The sealing part 128 comprises four U-shaped cross-sectional seal carriers, each having a sealing strip 152 on the top thereof. Each seal carrier 128 extending over an end of a side wall of the build sleeve 119. Biasing elements 129, in this embodiment linear wave springs, bias the seal carriers 128 away from the ends of the build sleeve walls. Fixed to the end of the seal carriers 128 are followers in the form of retractor bearings 130 arranged to follow an under-surface of the processing plate 112. The under-surface of the processing plate 112 has a first set of detents therein, which the retractor bearings 130 enter when the build chamber 118 is in the building position, and a second set of detents 131 therein, which the retractor bearings 130 enter when the build chamber 118 is in the debuilding position. When received within the detents 131, the sealing part is allowed to engage the under-surface of the processing plate 112 to surround the processing chamber aperture 102/debuilding chamber aperture 104 to seal any gap between the processing plate 112 and the build sleeve 119 to powder flow. The followers 130 are arranged to space the sealing part 128 from the processing plate 112 when not received in the detents 131. Such an arrangement avoids the need for additional actuators to achieve the movement of the sealing part 128 perpendicular to the lateral direction.

A removable aperture frame 132 is provided around one of the apertures 102, 104, preferably the debuilding chamber aperture 104. The aperture frame 132 can be removed to allow access to the sealing part 128 such that the sealing strip 152 can be removed and replaced as and when required.

The external door 105 to the debuilding chamber 103 leads to an airlock, loading/unloading chamber 134 as shown in FIGS. 1c and 1d. The airlock, loading/unloading chamber 134 comprises a transfer chamber door 135 that leads to the external environment. A build substrate loader and retraction mechanism 136 is located within the airlock, loading/unloading chamber 134 for automatically retracting the build sub state 117 to which the object is attached from the debuilding chamber 103 and for inserting replacement build substrates 117a into the debuilding chamber 103. A carriage 149 of the build substrate loader and retraction mechanism 136, which carries the build substrates 117, 117a into and out of the debuilding chamber 104 may comprise a brush or wiper 150 carried on an under surface thereof for wiping or brushing powder from an upper surface of the build platform 120 upon insertion of a replacement build substrate 117a into the debuilding chamber 120. The carriage 149 is driven into and out of the debuilding chamber 103 by a driving mechanism 151.

A process carried out by the powder bed fusion apparatus will now be described with reference to FIGS. 1a to 1d. Starting with the build chamber 118 in a building position shown in FIG. 1a, an object 144a is built in a layer-by-layer manner by forming layers of powder in the build chamber 118 through successive lowering of the build platform, spreading of powder layers and consolidation of material at selected locations in each layer using the laser beam directed by the scanner 106. At the same time (at least for part of the build of the object), a second object 144b, previously built by the powder bed fusion apparatus, may be manipulated by the mechanical mechanism 116 in the debuilding chamber 103 to free powder from the second object 144b and then removed from the apparatus, together with the build substrate 117a to which the second object 144b is attached through the airlock, loading/unloading chamber 134. At the same time as manipulating the second object 144b or in addition to manipulating the object 144b, gas may be injected through the gas inlets 133 to form gas jets for blowing powder from the second object. During freeing of powder from the second object 144b, the debuilding chamber aperture 104 is closed by the closure member 110. Furthermore, an inert atmosphere is maintained in the processing chamber 101, debuilding chamber 104 and transfer chamber 138.

After completion of the build of the object 144a, the build chamber 118 and drive mechanism 122 are moved by the translation mechanism to a debuilding position shown in FIG. 1b. In this debuilding position, the closure member 110 is retracted to open the debuilding chamber aperture 102 and the drive mechanism 122 is activated to drive the build platform 120 upwards to insert the loose powder, object 144a and build sub state 117 into the debuilding chamber 103 through the debuilding chamber aperture 104. Upon insertion, much of the loose powder around the object 144a will fall away into the powder collection channels 113a, 113b. This may be facilitated by gas jets formed by injecting gas through the gas inlets 133. The drive mechanism 122 may continue to raise the object 144a and build substrate 117 until the build substate 117 is secured within the retaining mechanism 116. As an alternative, the retaining mechanism may be arranged to move downwards, for example with a linear movement, such that the arms of the retaining mechanism 116 engage with the build substrate 117, which has been raised above the debuilding chamber aperture 104 by the drive mechanism 122.

Once the build substrate 117 is retained in the retaining mechanism 116, the build substate 117 is lifted clear of the build platform 120 through movement of the retaining mechanism such that a replacement build substate 117a can be inserted onto the build platform 120 below the raised build substate 117 and attached object 144a. A replacement build substrate 117a has been loaded into the build substrate loader and retraction mechanism 136 within the airlock, loading/unloading chamber 134, for example by a user 137, during the build of the object 144a. The loading of the replacement build substrate 117a is illustrated in FIG. 1d, but it will be understood that the replacement build substrate 117a would be loaded after the debuilding sequence of the previous object has been completed and the build substrate 117a transferred to and removed from the airlock, loading/unloading chamber 134.

Before insertion of the replacement build substrate 117a, the retaining mechanism 116 may undergo a single or multi-axes rotation sequence to encourage further powder remaining on the build sub state and/or around the object 144a to fall down the powder collection channels 113a, 113b. Typically, such a single or multi-axes rotation sequence is carried out at low speed and at small angles of rotation from the horizontal position in which the build substrate 117 is inserted into the retaining mechanism 116. After the sequence, the external door 105 to the debuilding chamber 103 is opened and the replacement build substrate 117a is inserted into the debuilding chamber by the build substrate loader and retraction mechanism 136, as shown in FIG. 1c. The build substrate loader and retraction mechanism 136 is retracted back into the airlock, loading/unloading chamber 134 and the external door 105 closed.

The replacement build substrate 117a is lowered by lowering the build platform 120 by the drive mechanism 122 until it is sufficiently clear of the debuilding chamber aperture 104 to allow the closure member 110 to be moved across to close the debuilding chamber aperture 104 (FIG. 1d). The build chamber 118 and the drive mechanism can then be moved back to the building position and the next build commenced. During the next build, the retaining mechanism 116 executes a rotation sequence to remove further powder from the object 144a, returning the process back to the step shown in FIG. 1a. Powder released from the object 144a falls into the collection channels 113a, 113b and onto the closure member 110. Vibration of the closure member 110 by the vibrators causes powder that falls onto the closure member 110 to move over the surface to the collection channels.

Powder that enters into the collection hopper 115 from the collection channels 113a, 113 is transported pneumatically by an inert gas flow to a cyclone separator 139, which separates powder particles from the gas flow of the pneumatic transport (the transport conduits are not shown). The separated powder particles fall onto a sieve (not shown) which separates out the oversized particles, whilst the remaining powder is allowed to fall into powder hopper 109 for use in a subsequent build.

In another embodiment (not shown), the loading/unloading chamber 134 is not an airlock chamber or no loading/unloading chamber is provided at all, for example the object 144a and replacement build substrate 117a maybe unloaded/or loaded, respectively from an open platform. In such an embodiment, the inert atmosphere in the debuilding chamber 103 is compromised when the external door 105 is opened. In this case, once the external door 105 has been closed again, the debuilding chamber is purged before the building chamber 118 is moved back to the building position. In such an embodiment, the closure member 110 may provide a hermetic seal sealing the transfer chamber 138 and processing chamber 101 from the air allowed into the debuilding chamber 103 on opening door 105. Alternatively, the machine and in particular the transfer chamber 138 acting as an inert gas trap (or U-bend) trapping inert gas, such as argon, that is heavier than air and as such preventing the flow of air to the processing chamber 101. This embodiment simplifies the machine in that it removes the need for the additional loading/unloading chamber but has the potential disadvantage that the powder in the debuilding chamber is exposed to air on insertion of the replacement build substrate 117a.

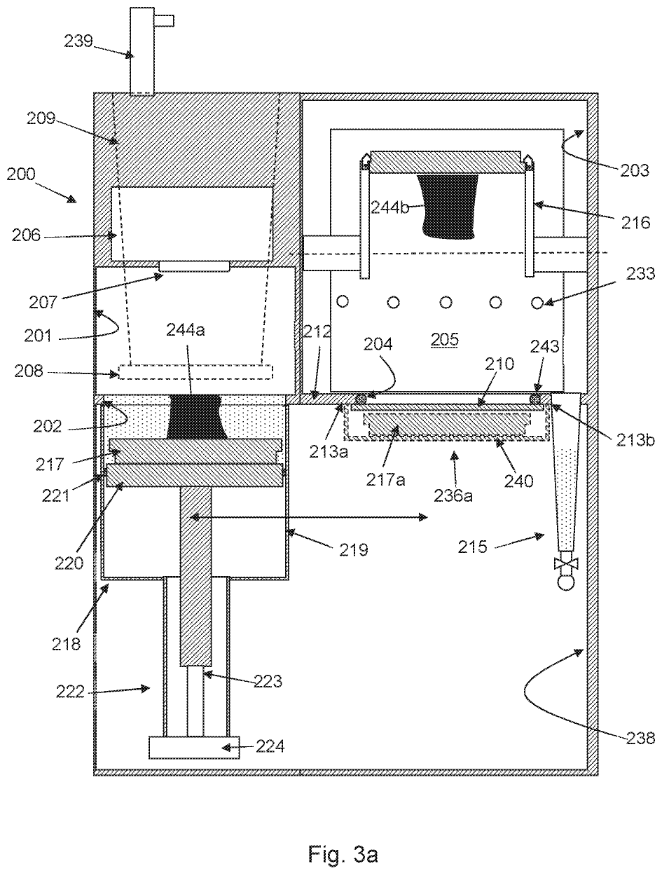

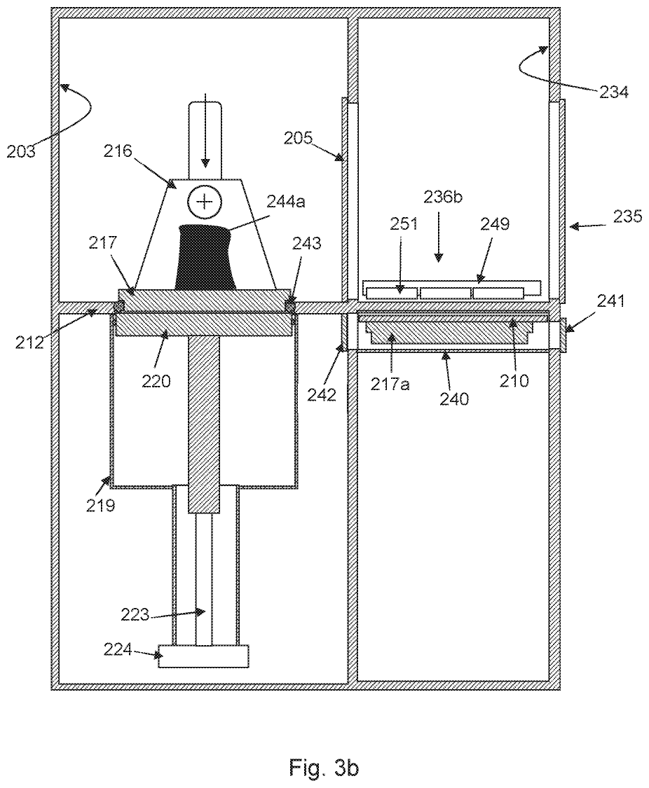

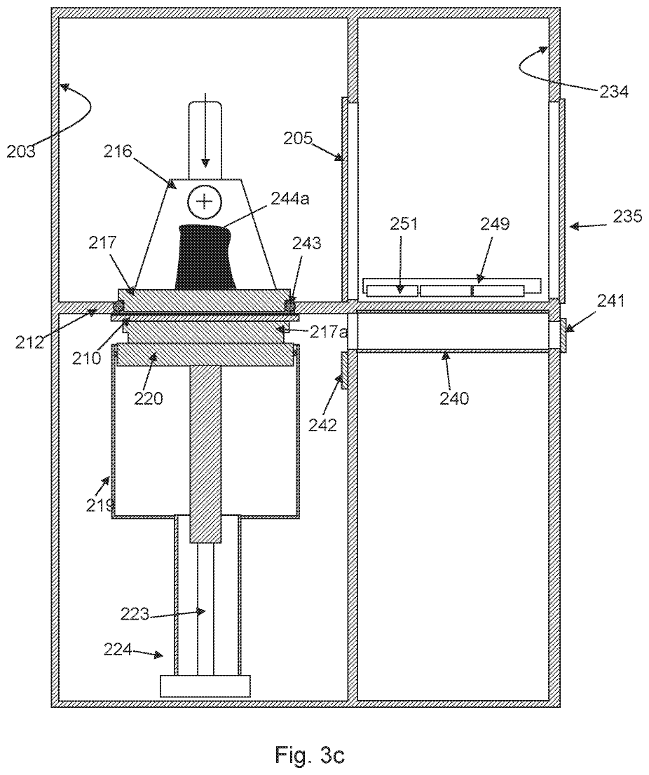

A further powder bed fusion apparatus is shown in FIGS. 3a to 3c. Like reference numerals but in the series 200 are used for features of the second embodiment that correspond to like-features of the first embodiment shown in FIGS. 1a to 1c. Features of the second embodiment that are the same or substantially the same as the corresponding feature of the first embodiment will not be described in detail again and reference is made to the above description of the first embodiment for a description of such features.

The second embodiment differs from the first embodiment in that a build substate loader 236a is provided to load the replacement build substrate 217a onto the build platform 220 when the closure member 210 has closed the debuilding chamber aperture 204. The build substrate loader 236a is located below the processing plate 212 and comprises a loading chamber 240 having an external door 241 for introducing a build substrate 217a into the loading chamber 240 and an internal door 242 for allowing the build substrate to be loaded into the build chamber 218. A purging device (not shown) is provided for purging the loading chamber 240 of air after a build substrate 217a has been placed into the loading chamber 240 and the external door 241 has been closed and before the internal door 242 is opened. The purging device comprises an inert gas inlet to the loading chamber 240 connected to a source of pressurised inert gas, such as argon or nitrogen, for introducing the inert gas into the loading chamber 240 and a vent for venting air pushed from the loading chamber by the pressurised inert gas.

A lower portion of the closure member 210 comprises attachments such that the replacement build substrate 217a can be attached to and suspended below the closure member 210. The closure member 210 is arranged to move into and out of the loading chamber 240.

The build sleeve 219 is arranged such that, at least in the debuilding position, the build sleeve 219 is movable from a position (shown in FIG. 3b) engaging the debuilding chamber 203, in this case the processing plate 212, such that the build sleeve 219 surrounds the debuilding chamber aperture 204, and a position spaced from the debuilding chamber 203 (as shown in FIG. 3c) such that the replacement build substrate 217a can be loaded on to the build platform 220 using the build substrate loader 236.

The loading/unloading chamber 234 need not be an airlock chamber or need not be provided at all. An inflatable seal 243 is provided in the debuilding chamber aperture 204 to hermetically seal the transfer chamber 238 and processing chamber 201 from the debuilding chamber 203 when the external door 205 is opened, as explained in more detail below.

A process carried out by the powder bed fusion apparatus will now be described with reference to FIGS. 3a to 3c. Starting with the build chamber 218 in a building position shown in FIG. 3a, an object is built in a layer-by-layer manner by forming layers of powder in the build chamber 218 through successive lowering of the build platform 220, spreading of powder layers and consolidation of material at selected locations in each layer using the laser beam directed by the scanner 206. At the same time (at least for part of the build of the object), a second object 244b, previously built by the powder bed fusion apparatus, may be manipulated by the mechanical mechanism 216 in the debuilding chamber 203 to free powder from the second object 244b and then removed from the apparatus together with the build substrate to which the second object 244a is attached through the loading/unloading chamber 234. During freeing of powder from the second object 244b, the debuilding chamber aperture 204 is closed by the closure member 210. Furthermore, an inert atmosphere is maintained in the processing chamber 201, debuilding chamber 204 and transfer chamber 238.

After completion of the build of the object 244a, the build chamber 218 and drive mechanism 222 are moved by the translation mechanism to a debuilding position shown in FIG. 3b. In this debuilding position, the inflatable seal 243 is deflated and the closure member 210 is retracted into the loading chamber 240 to open the debuilding chamber aperture 202. A replacement build substrate 217a has been loaded into the loading chamber 240 by a user and, on retraction of the closure member 210 into the loading chamber 240, the attachments on the closure member 210 pick up the replacement build substrate 217a.

The drive mechanism 222 is activated to drive the build platform 220 upwards to insert the loose powder, object 244a and build substate 217 into the debuilding chamber 203 through the open debuilding chamber aperture 204. Upon insertion, much of the loose powder around the object 244a will fall away into the powder collection channels 213. The drive mechanism 222 continues to raise the object and build substrate 217 until the build substate 217 is located within the debuilding chamber aperture 204. The inflatable seal 243 is then inflated to, together with the build substrate 217, seal the debuilding chamber aperture 204 to powder flow. This is shown in FIG. 3b.

The build sleeve 219 is then lowered to the position, shown in FIG. 3c, such that the closure member 210 can move across the debuilding chamber aperture 204 and there is sufficient room for the replacement build substrate 217a carried below the closure member 210 to be inserted above the build platform 220. The build platform 220 is then moved to disengage the replacement build substrate 217a from the closure member 210 such that the replacement build substrate 217a is carried by the build platform 220. The build chamber 218 is then moved back to the building position (shown in FIG. 3a) to begin the next build.

The retaining mechanism 216 is lowered such that the arms of the retaining member engage with and retain the build substrate 217 located within the debuilding chamber aperture 204. Once the build substrate 217 is retained in the retaining mechanism 216, the build sub state 117 is lifted clear of closure member 210 such that the retaining mechanism can rotate the object 244a to remove loose powder contained within the object 244a. After the rotation sequence, the external door 205 to the debuilding chamber 103 is opened and the carriage of the retraction mechanism 236b is extended into the debuilding chamber 203. The retaining mechanism 216 lowers the build substrate 217 and object 244a onto the carriage and the interaction of the retaining mechanism 216 with the carriage releases the build substrate 217 and object 244a onto the carriage. The carriage is then withdrawn from the debuilding chamber 203 to carry the build substrate 217 and object 244a out of the debuilding chamber 203. The door 205 is closed and the debuilding chamber purged of air and refilled with the inert gas. The user can then remove the object 244a and build substrate 217 for further processing at a convenient time.

Powder that enters into the collection hopper 215 from the collection channels 213 is transported pneumatically by an inert gas flow to the cyclone 239, which separates powder particles from the gas flow of the pneumatic transport (the transport conduits are not shown). The separated powder particles fall onto a sieve (not shown) which separates out the oversized particles, whilst the remaining powder is allowed to fall into powder hopper 209 for use in a subsequent build. A sealing element may be provided for sealing the collection channels to the debuilding chamber 203 when the external door 205 is opened.

This embodiment has the advantages that the powder is kept away from the air that is introduced upon opening the external door 205 to the debuilding chamber 203. However, the embodiment has the additional complication of a mechanism to lower the build sleeve 219.

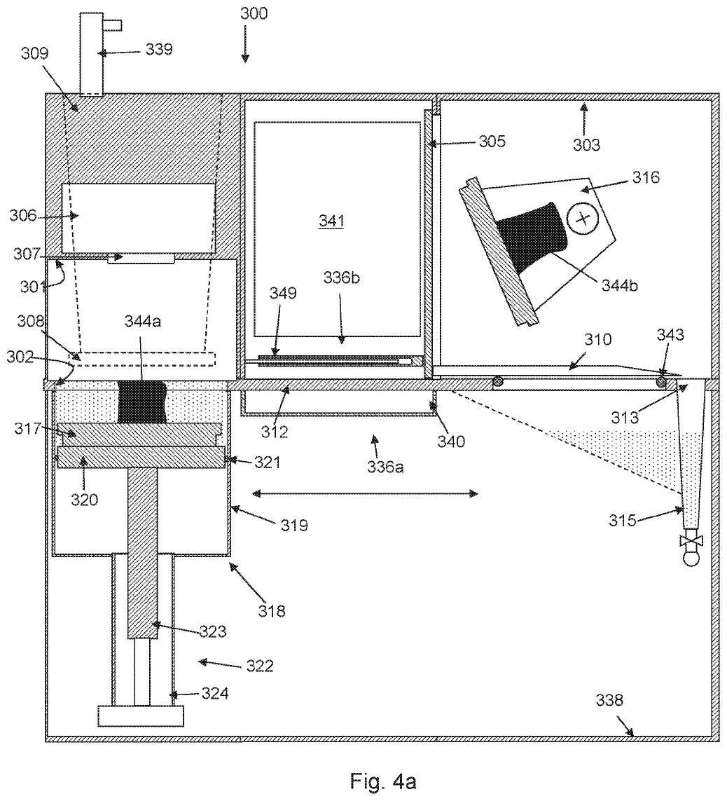

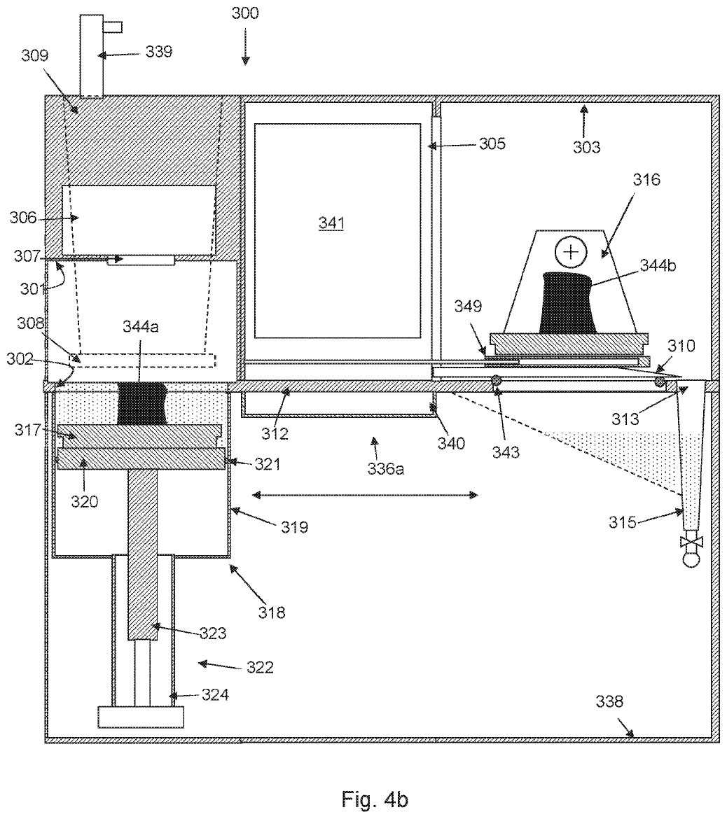

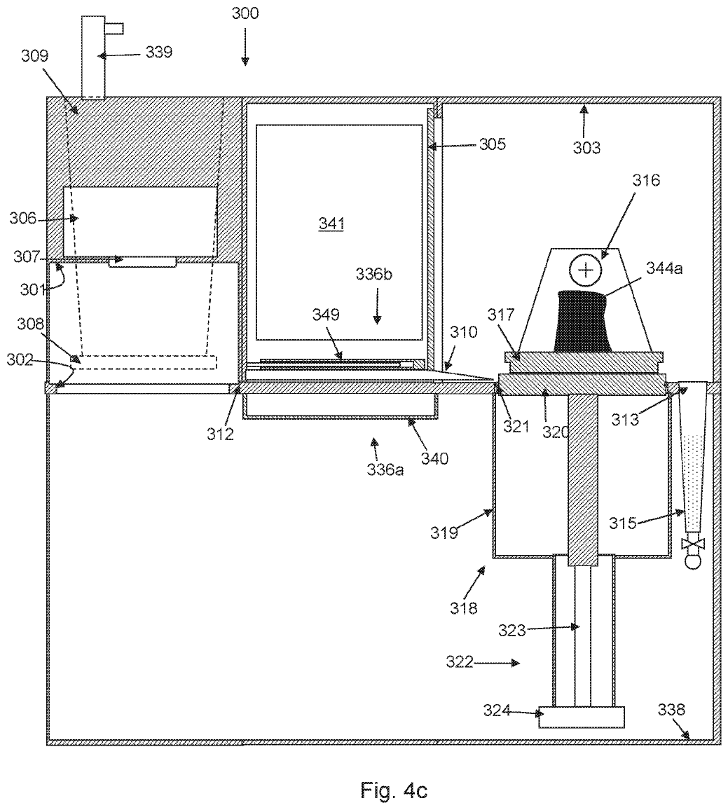

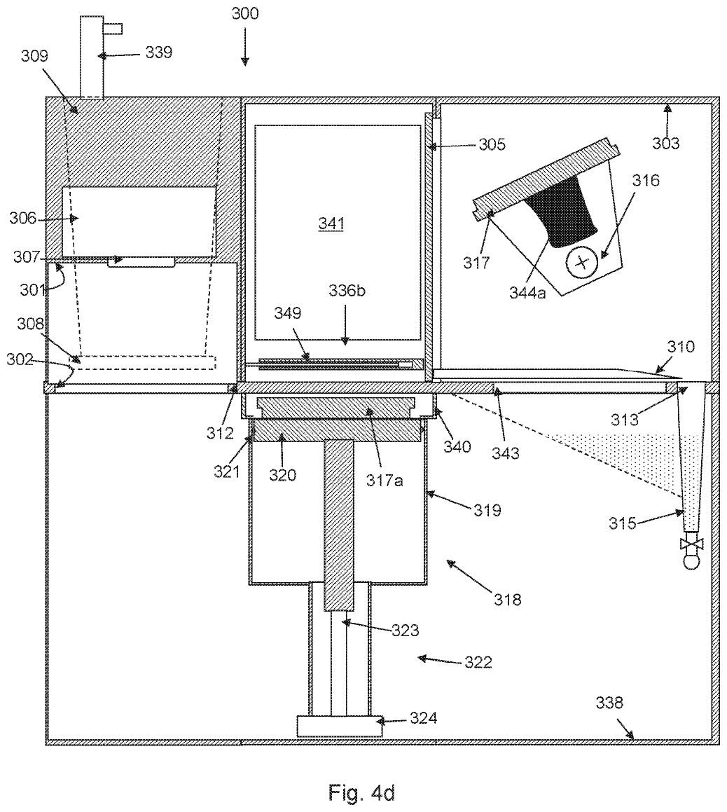

A further powder bed fusion apparatus is shown in FIGS. 4a to 4d. Like reference numerals but in the series 300 are used for features of the third embodiment that correspond to like-features of the first and second embodiments shown in FIGS. 4a to 4d. Features of the third embodiment that are the same or substantially the same as the corresponding feature of the first and second embodiments will not be described in detail again and reference is made to the above description of the first and second embodiments for a description of such features.

In this embodiment the transfer chamber 334 is provided between the processing chamber 301 and debuilding chamber 303 and a build substrate loader 336a located below the transfer chamber 334. Furthermore, unlike the first and second embodiments, the closure member 310 is provided above the processing plate 312 and is retractable into the transfer chamber 338 below retraction device 236b. A wiper or brush (not shown) is attached to a lower surface or edge of the closure member 310, the wiper or brush arranged to engage with the upper surface of the build platform 120 to sweep powder from the upper surface (as described in more detail below).

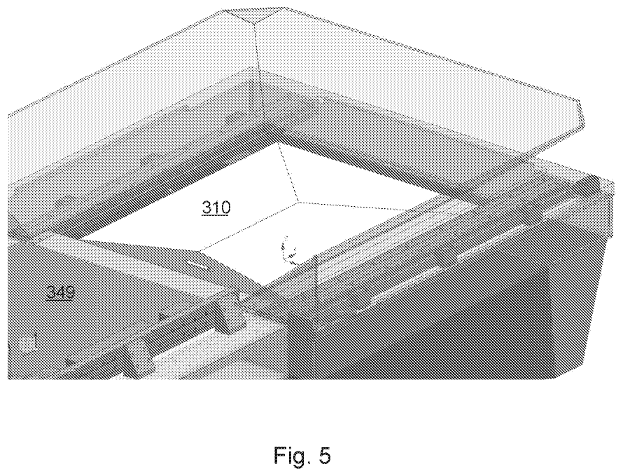

FIG. 5 illustrates the closure member 310 covering the debuilding chamber aperture 304. Up upper surface of the closure member 310 comprises sloping surfaces, in this embodiment, three differently angled surfaces sloping downwards from a central apex. Each of the sloping surfaces terminates at an edge of the closure member 110 that overhangs a powder collection channel 313 when the closure member 310 is over the debuilding chamber aperture 304.

As shown in FIG. 5 the lower side walls of the debuilding chamber 303 may also be at an angle to the vertical and horizontal to encourage powder flow into the powder collection channels 313.

A process carried out by the powder bed fusion apparatus will now be described with reference to FIGS. 4a to 4d. Starting with the build chamber 318 in a building position shown in FIG. 4a, an object 344a is built in a layer-by-layer manner by forming layers of powder in the build chamber 318 through successive lowering of the build platform 320, spreading of powder layers and consolidation of material at selected locations in each layer using the laser beam directed by the scanner 306. At the same time (at least for part of the build of the object), a second object 344b, previously built by the powder bed fusion apparatus, may be manipulated by the mechanical mechanism 316 in the debuilding chamber 303 to free powder from the second object 344b.

After sufficient powder has been removed from the second object 344b, the second object 344b is transferred together with the build substrate to which it is attached from the debuilding chamber 303 into the airlock, transfer chamber 334. This is achieved using retraction device 336b. Upon completion of the rotation sequence by the retaining mechanism 316, door 305 to the transfer chamber 334 is opened and the carriage of the retraction device 336b is extended into the debuilding chamber 303. The retaining mechanism 316 is moved to locate the build substrate retained therein on to the carriage. Interaction of the retaining mechanism 316 with the carriage causes the build substrate to be released from the retaining mechanism 316 such that the build substrate and object rest on the carriage. The carriage is then withdrawn into the transfer chamber 334 carrying the build substrate and second object 344b with it. The second object 344b may be removed from the transfer chamber by a user before the object 344a being built is transferred into the debuilding chamber 303.

During freeing of powder from the second object 344b, the debuilding chamber aperture 304 is closed by the closure member 310. Furthermore, an inert atmosphere is maintained in the processing chamber 301, debuilding chamber 304 and transfer chamber 338.

After completion of the build of the object 344a, the build chamber 318 and drive mechanism 322 are moved by the translation mechanism to a debuilding position shown in FIG. 4c. In this debuilding position, an inflatable seal (not shown) is deflated and the closure member 310 is retracted into the transfer chamber 334 to open the debuilding chamber aperture 304. Door 305 may be opened only partially, providing sufficient room for the closure member 310 to move into the transfer chamber 334 but still closing the majority of the door opening between the debuilding chamber 303 and the transfer chamber 334.

The drive mechanism 322 is activated to drive the build platform 320 upwards to insert the loose powder, object 344a and build substate 317 into the debuilding chamber 303 through the open debuilding chamber aperture 304. Upon insertion, much of the loose powder around the object 344a will fall away into the powder collection channels 313. The drive mechanism 322 may continue to raise the object and build substrate 317 until the build substate 317 is secured within the retaining mechanism 316. As an alternative, the retaining mechanism 316 may be arranged to move downwards, for example with a linear movement, such that the arms of the retaining mechanism 316 engage with the build substrate 317, which has been raised above the debuilding chamber aperture 304 by the drive mechanism 322. This is shown in FIG. 4c.

Once the build substrate 317 is retained in the retaining mechanism 316, the build substate 317 is lifted clear of the build platform 320 through movement of the retaining mechanism 316 such that the closure member can move across the debuilding chamber aperture 304 to close the debuilding chamber aperture 304 and there is sufficient room to rotate the object 344a and build substrate 317 within the debuilding chamber 303. Movement of the closure member 310 across the debuilding chamber aperture causes the brush or wiper attached thereto to brush loose powder from the top surface of the building platform 320. The inflatable seals are then inflated to seal the debuilding chamber aperture 304 to powder flow. Door 305 is also closed. Before closing of the debuilding chamber aperture 304 with the closure member 310, the retaining mechanism 316 may undergo a single or multi-axes rotation sequence to encourage further powder remaining on the build substate 317 and/or around the object 344a to fall down the powder collection channels 313. Typically, such a single or multi-axes rotation sequence is carried out at low speed and at small angles of rotation from the horizontal position in which the build substrate 317 is inserted into the retaining mechanism 316.

The build sleeve 319 is then lowered to disengage from the debuilding chamber 303 and the build chamber 318 moved to a build substrate loading position shown in FIG. 4d. The build sleeve 319 is lowered such that there is sufficient room for the replacement build substrate 317a to be inserted above the build platform 320 by the build substrate loader 336a. Once the replacement build substrate 317 has been placed on the build platform 320, the build chamber 318 is moved back to the building position (shown in FIG. 4a) to begin the next build.

Powder that enters into the collection hopper 315 from the collection channels 313 is transported pneumatically by an inert gas flow to the cyclone 339, which separates powder particles from the gas flow of the pneumatic transport (the transport conduits are not shown). The separated powder particles fall onto a sieve (not shown) which separates out the oversized particles, whilst the remaining powder is allowed to fall into powder hopper 309 for use in a subsequent build.

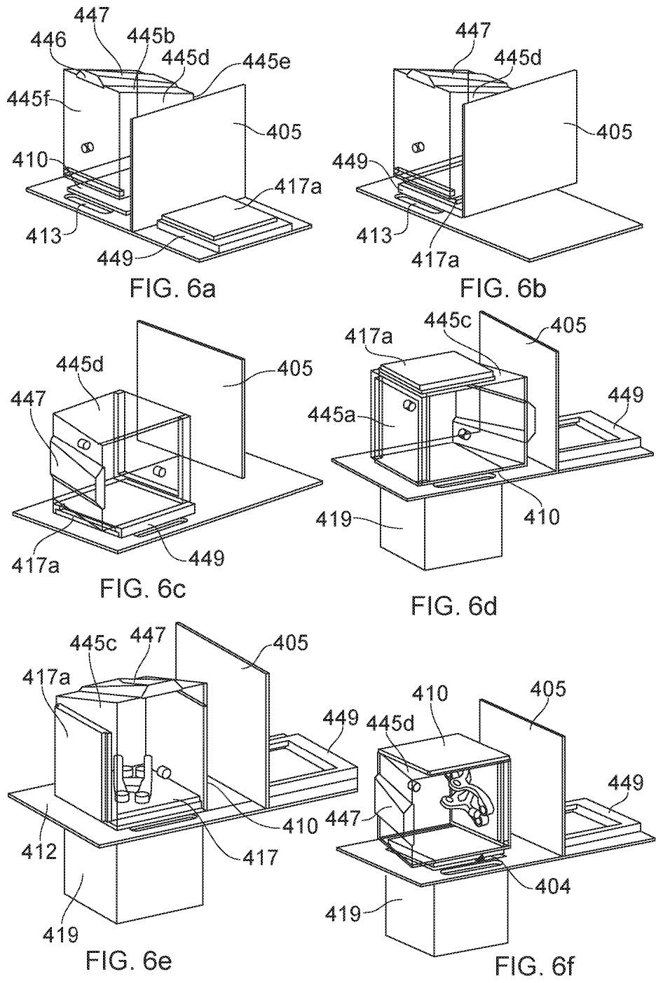

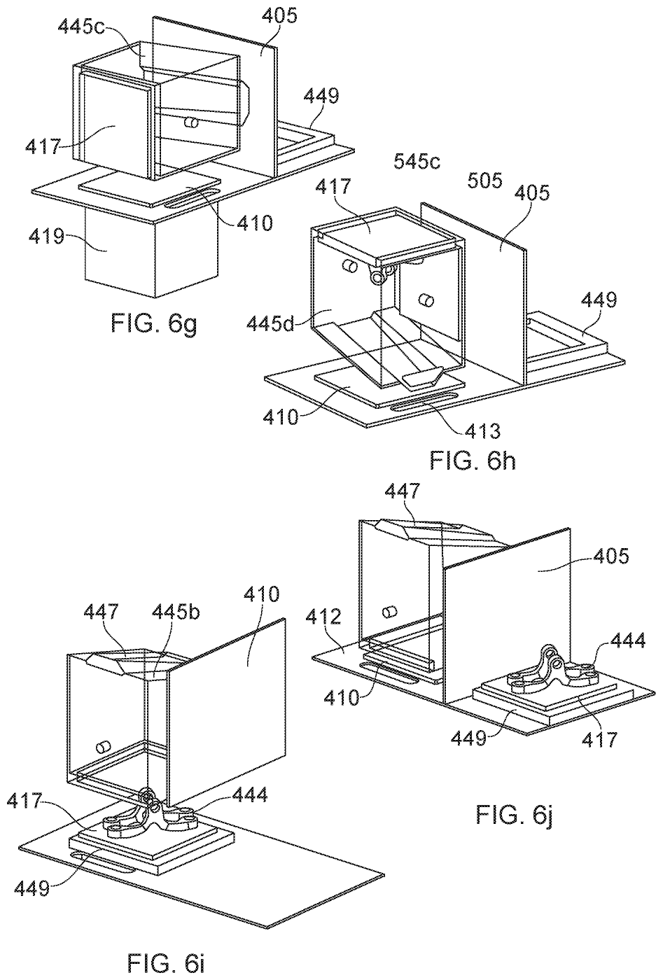

FIGS. 6a to 6j illustrate a process carried out by a retaining mechanism 416 and insertion and retraction mechanism 436 according to another embodiment of the invention. In this embodiment, the retaining mechanism 416 comprises a container having an open side 445a for receiving the object 444 and the build substrate 417 and five closed sides 445b, 445c, 445d, 445e, 445f. A first closed side of the container, preferably the closed side 445b opposite the open side 445a, comprises a powder outlet 446, optionally a valve, and a funnel or chute 447 leading to the powder outlet 446. A second closed side 445c of the container comprises attachment formations (not shown) for retaining a replacement build substrate 417a. A third closed side 445d, preferably opposite the further side 445c comprises attachment formations (not shown) for retaining the closure member 410. The open side 445a and closed sides 445b, 445c and 445d are all located on the container such that rotation of the container about one or more axis can locate the sides 445a, 445b, 445c, 445d adjacent the debuilding chamber aperture 404.

In use, the external door 405 is opened and insertion and retraction mechanism 436 is activated to insert a replacement build substrate 417a into the debuilding chamber 403 above the closure member 410 (FIG. 6b). The retaining member 416 rotates such that the second closed side 445c of the container is adjacent to the replacement build substrate 417a and the retaining mechanism 416 is lowered such that the attachment formation on the second closed side 445c engage with the replacement build substrate 417a to retain the replacement build substrate 417a (FIG. 6c). The carriage of the insertion and retraction mechanism 436 is then withdrawn from the debuilding chamber 403 and the external door 405 closed.

When the build chamber 418 has been moved to the debuilding position after completion of a build, the container is rotated to locate the third closed side 445d adjacent the closure member 410 and the retaining mechanism lowered such that the attachment formation of the third closed side 445c engage with and retains the closure member 410 (FIG. 6d). The container is then raised, rotated, and then lowered such that the open side 445a of the container engages with the floor of the debuilding chamber 403 surrounding the now open debuilding chamber aperture 404. The drive mechanism is then activated to drive the build platform up and with it the powder bed, object 444 and build substrate 417 into the container until the build substrate 417 engages with and is secured to the container by a fastener (not shown).

The container then rotates again located the replacement build substrate 417a over the debuilding chamber aperture 404 (FIG. 60. The build platform is raised to pickup the replacement build substrate 417a from the container and then lowered back into the build sleeve 419. The container is then rotated to place the closure member 410 back over the debuilding chamber aperture 404 (FIG. 6g). Once the closure member 410 is in place over the debuilding chamber aperture 404, the container is rotated to carry out a sequence of moves to remove powder form the object 444. This sequence will include one or more occasions in which the powder outlet is located over the powder collection channel 413 (and, if a valve is present, the valve opened) to allow powder in the container to flow into the powder collection channel 413 (FIG. 6h).

Once the depowdering sequence has been completed, the container locates the build substrate 417 adjacent to and above the closure member. Door 405 is opened, and the carriage of the insertion and retraction mechanism is inserted into the debuilding chamber 404 to engage with the build substrate 417. The container is then raised such that a bottom of the container is clear of the object (FIG. 6i). The object and build substrate 417 are then removed from the debuilding chamber 404 through retraction of the carriage and door 405 closed (FIG. 6j). A user can then remove the object and build substrate and replace it on the carriage with a replacement build substrate, returning the apparatus back to the condition shown in FIG. 6a.

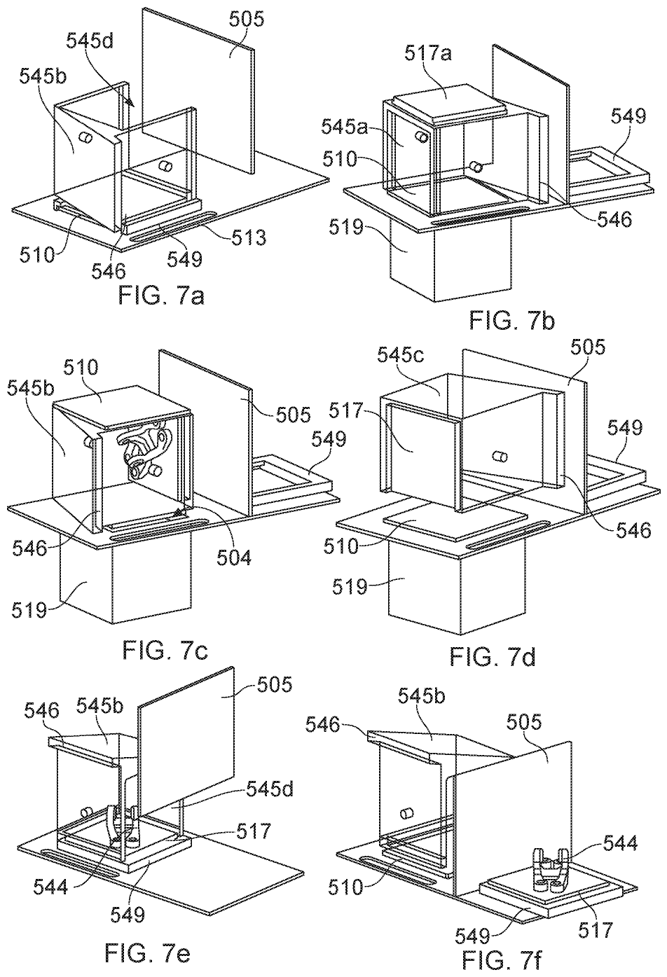

FIGS. 7a to 7f illustrate a process carried out by a retaining mechanism 516 and insertion and retraction mechanism 536 according to another embodiment of the invention. This embodiment is similar to the previous embodiment in which the retaining mechanism 516 comprises a container. However, in this embodiment, the container has two open sides 545a and 545d. As in the previous embodiment, the replacement build substrate 517a is picked up by closed side 545b of the container (FIG. 7a). The container is then rotated to pick up the closure member using open side 545d (FIG. 7b). The retention of the closure member 510 by the container closes the open side 545d of the container. As in the previous embodiment, the powder, object and build substrate 517 are inserted into the container and a sequence of moves are executed to release powder from the object and deposit the powder into the collection channel 513 (FIG. 7c). The closure member is then placed back over the debuilding chamber aperture 504, opening one side of the container allowing powder to fall freely from the container into the debuilding chamber 504.

As with the previous embodiment, the container is rotated again such that the build substrate 517 attached to the container can be picked up by the carriage of the insertion and retraction mechanism 536. However, because side 546d of the container is now open due to removal of the closure member 510, the object can be carried from the container by the carriage without raising the container (FIGS. 7e and 7f).

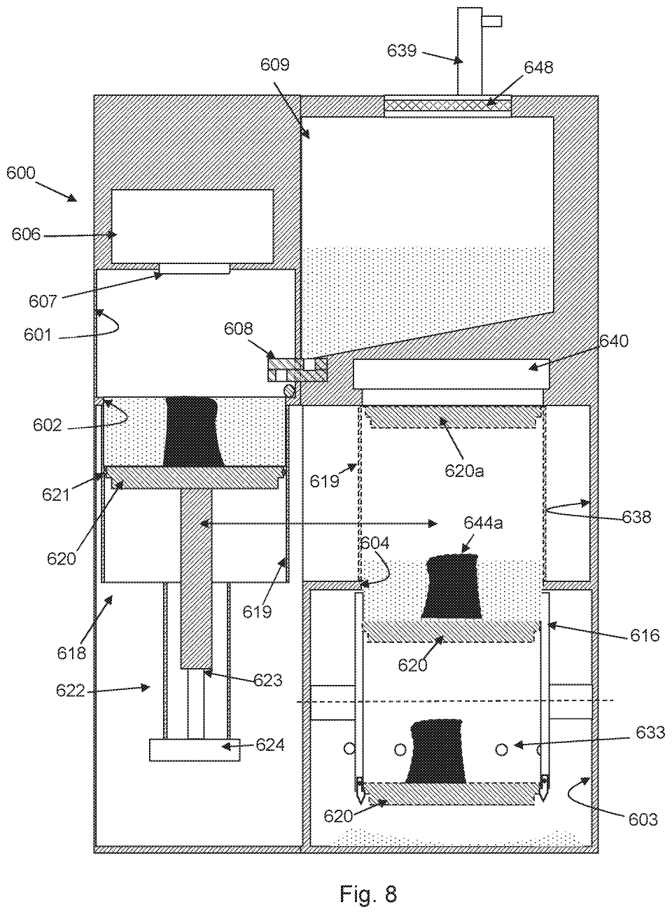

A powder bed fusion apparatus according to a further embodiment of the invention is shown in FIG. 8. Like reference numerals but in the series 600 are used for features of the further embodiment that correspond to like-features of the above-described embodiments shown in FIGS. 1 to 7. Features of the further embodiment that are the same or substantially the same as the corresponding feature of the above-described embodiments will not be described in detail again and reference is made to the above description for a description of such features.

In this embodiment, rather than the debuilding chamber 603 being located above the build chamber 618, the debuilding chamber 603 is located such that the debuilding chamber 603 is below the build chamber 618 when the build chamber 618 is in the debuilding position. In this embodiment, after completing the build, the build chamber 618 is moved to the debuilding position (shown in dotted lines in FIG. 8) but the drive mechanism 612 remains below the processing chamber 601. Accordingly, the build platform 620 is decoupled from the drive shaft 632 and the build platform 620 is retained in the build sleeve 619 during the translation to the debuilding position.

When the build chamber 618 reaches the debuilding position, the build platform 620 is allowed to exit the bottom of the build sleeve 619 and is received by retaining mechanism 616. The retaining mechanism 616 may comprise a mechanism for cushioning the decent of the build platform 620 and object as it descends into the retaining mechanism 616. In this embodiment, the build platform 620 comprising build platform seals 621 may also be the build substrate on which the object is formed. Once the build platform 620, object and powder have been inserted into the debuilding chamber 603 a closure element (not shown) is moved across the debuilding chamber aperture 604 is close the aperture.

A build substrate loader 636a is provided above the debuilding chamber 603 such that a replacement build platform 620a can be inserted into the build sleeve 610 from above when in the debuilding position. The replacement build platform 620a may be loaded into the build sleeve 610 before or after the debuilding chamber aperture 604 has been closed by the closure member. The build chamber 618 now comprising the replacement build platform is then translated back to the building position to carry out the next build. In the building position, the drive mechanism 622 couples with the replacement build platform 620a for the commencement of the next build.

As with the previous embodiments, once the debuilding chamber aperture 604 is closed by the closure member, the retaining member 616 executes a single or multi-axes rotation sequence to remove powder from the object. Powder that is released is collected in a collection hopper (not shown) and, from the collection hopper, is transported pneumatically by an inert gas flow to the cyclone 639, which separates powder particles from the gas flow of the pneumatic transport (the transport conduits are not shown). The separated powder particles fall onto a sieve 648 which separates out the oversized particles, whilst the remaining powder is allowed to fall into powder hopper 609 for use in a subsequent build. Once the rotation sequence has been completed, the object can be removed from an external door (not shown) to the debuilding chamber 603.

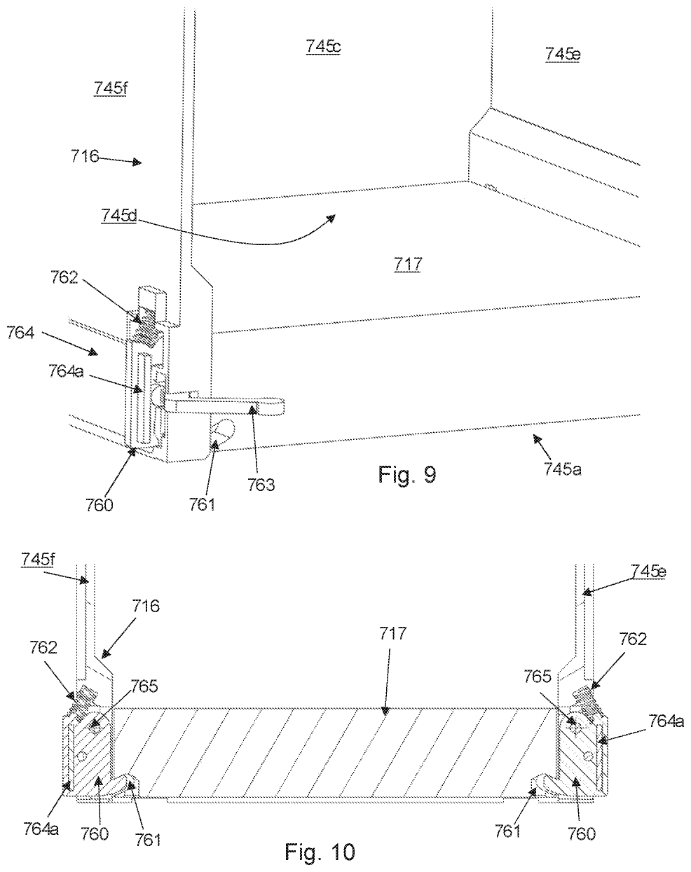

A powder bed fusion apparatus according to a further embodiment of the invention is shown in FIGS. 9 to 13. Like reference numerals but in the series 700 are used for features of the further embodiment that correspond to like-features of the above-described embodiments shown in FIGS. 1 to 8. Features of the further embodiment that are the same or substantially the same as the corresponding feature of the above-described embodiments will not be described in detail again and reference is made to the above description for a description of such features.

Like the embodiment described with reference to FIGS. 7a to 7f, the retaining mechanism 716 comprises a rotatable container. The container has two open sides 745a, 745d and four closed sides 745c, 745e, 745f (and a closed side (not shown) opposite open side 745a). Open side 745a is for receiving the object and the build substrate 717 (FIGS. 9 and 10 show this open side 745a closed by the build substrate 717) and open side 745d allows the object to be removed from the container without raising the container. Powder will fall out of open side 745d as the object and powder bed is pushed into the container through open side 745a and when the build substrate and object are retained in the retaining mechanism 716. The container is oriented such that the open side 745d of the container, which remains open when the build substrate 717 and object are attached, can be located adjacent (faces on to) a powder collection channel 713 in the floor of the debuilding chamber 703 and is positioned in this way when receiving the build substrate 717 and object from the build chamber 718. In this way, the container acts to direct powder towards the powder collection channel 713.

To retain the build substrate 717, the container is provided with retaining formations in the form of two clips. Each clip comprises a pair of catches 760 (only one of which is shown), each catch 760 having a protrusion thereon for extending into a slot 761 in the build substrate 717. The catch 760 is rotatable about an axis 765 and is biased into engagement with the slot 761 by a biasing member, in this embodiment in the form of spring 762. The pair of catches 760 on each side of the container are joined by a plate 764 that extends through a slot in each catch 760. A releasing arm 763 adjacent one of the catches 760 of the pair is arranged to engage with an end portion (an abutment) 764a extending from the catch 760. The releasing arm 763 is pivotable about a vertical axis and is arranged to be engaged by a build substrate carrier (not shown) as the build substrate carrier moves to a position below the retaining mechanism 716. Engagement of the releasing arms 763 with the build substrate carrier causes the retaining arm 763 to pivot and engage the abutment 764a, forcing each catch 760 of the pair out from slot 761 and releasing the build substrate 717 with object attached onto the build substrate carrier.

Like previous embodiments, a replacement build substrate (not shown) is picked up by the container. However, in this embodiment, the replacement build substrate is picked up by the closed side opposite open side 745a. This closed side of the container has clips and arms (not shown) like those described above for retaining the replacement build substrate.

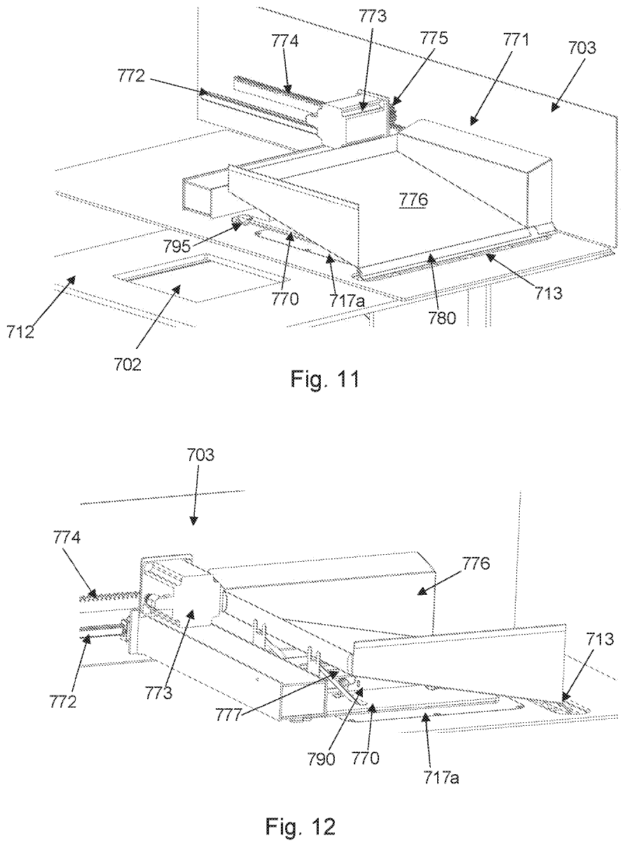

FIGS. 11 to 13 show a closure mechanism 771 for moving a closure member 770 over and closing the debuilding chamber aperture 704. The closure mechanism 771 comprises closure member 770 having at least a lower surface of compressive material 770a that can provide a powder and gas seal when engaged with a surface of the debuilding chamber 703. The closure member 770 is a resilient plate that can be clamped over the debuilding chamber aperture 704 and raised away from the floor of the debuilding chamber 703 for moving the closure member 770 to a side of the debuilding chamber aperture 704.

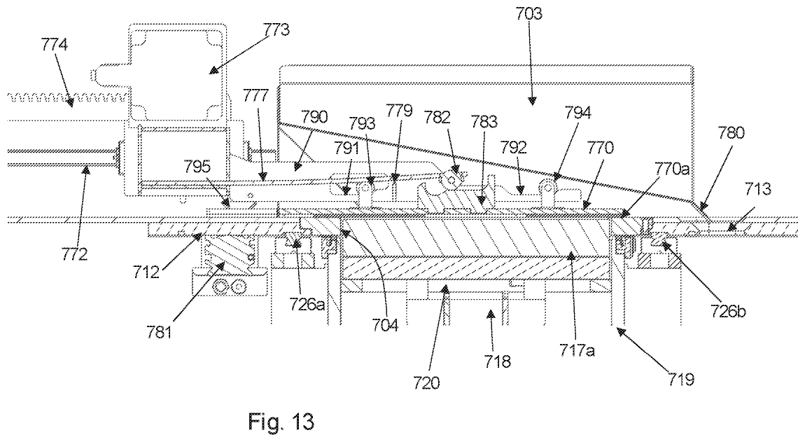

A linear cam 783 is provided on the closure member 770. A follower 782 is located on a biasing element 777 (in this embodiment a planar spring) that biases the follower 782 towards the linear cam 783. The spring element 777 is connected to a drive in the form of motor 773, pinion 775 and rack 774. Movement of the spring element 777 driven by the drive is guided by guide rail 772. The linear cam 783 is profiled having a detent, which, on receiving the follower 782, allows the spring element 777 to be positioned in a position such that the spring element 777 exerts little force onto the closure member 770. In this embodiment, this is achieved by providing a preloading element 779 against which the spring element 777 sits when the follower 782 is received in the detent of the linear cam 783 such that the spring 777 provides minimal or no force to the linear cam 783. With the follower 782 located in the detent on the linear cam 783, further movement (to the left in FIG. 13) of the spring element 777 will cause the closure member 770 to be pulled clear of the debuilding chamber aperture 704.

A counter cam 790 is provided for lifting the closure member 770 from the floor of the debuilding chamber 703. The counter cam 790 has two cam profiles 791 and 792, each of which receives a corresponding follower 793, 794 attached to the closure member 770. The cam profiles 791 and 792 comprise raised regions arranged such that when the followers 793, 794 move onto these raised regions the closure member 770 is lifted from engagement with the debuilding chamber floor. When the followers 793, 794 move to the lower region of the cam profiles 791, 792, the closure member 770 is allowed to drop into engagement with the debuilding chamber floor.

A boss 795 is provided on the debuilding chamber floor, the closure member 770 arranged to engage the boss 795 when located above the debuilding chamber aperture 704 (see FIG. 11), the boss 795 preventing movement of the closure member 770 beyond this point. However, the planar spring 777 and counter cam 790 can be driven further (to the right in FIG. 13), causing the followers 793 and 794 to move to the lower regions of profiles 791, 792 such that the closure member 770 is allowed to engage with the floor of the debuilding chamber 703. At the same time or slightly thereafter, the follower 782 moves out of the detent of linear cam 783 causing the planar spring 779 to be lifted off the preloader 779 and exert a force on the closure member 770 via the linear cam 783 to clamp the closure member 770 over the debuilding chamber aperture 704. To open the debuilding chamber aperture 704, the reverse process occurs.

The closure mechanism 771 further comprises a sloping powder tray 776 that directs powder freed from the object into powder collection channel 713 and a wiper 780 for wiping powder that falls onto the debuilding chamber floor and build platform 720 into the powder collection channel 713

In operation, on locating the build chamber 718 containing a completed build in the debuilding position, the closure mechanism 771 is driven to move the closure member 770 from the debuilding chamber aperture 704. The retaining mechanism 716 is lowered such that side walls of the container are close to or engage with a floor of the debuilding chamber 703. The build platform 720 is then activated to insert the object and build substrate 717 into the debuilding chamber 703 such that the build substrate 717 engages with the catches 760 pushing the catches 760 away against the biasing of springs 762 such that the build substrate 717 is inserted into the container. The build platform 720 is driven upwards until the catches 760 are received in slots 761 such that the build substrate 717 is retained by the retaining mechanism 716. The retaining mechanism 716 is then driven upwards lifting the object and build substrate 717 off the build platform 720 a sufficient distance such that the closure mechanism 771 can be inserted therebetween and the retaining mechanism 716 rotated later in the debuilding process.

The majority of the powder freed at this stage will fall into the powder collection channel 713. However, some may fall onto the upper surface of the build platform 720. This powder is removed by the wiper 780 of the closure mechanism 771 as the closure mechanism 771 is activated to close the debuilding chamber aperture 704 with the closure member 770. During or before the closure of the debuilding chamber aperture 704, the build platform 720 may be driven repeatedly up and down, preferably in short, sharp movements (so called chirping of the build platform 720) to free powder from any recesses or other powder traps in or on the build platform 720. With the debuilding chamber aperture 704 closed, the container of the retaining mechanism 716 may be rotated to free more powder from the object. This freed powder will fall onto the powder tray 776 and into the powder collection channel 713. This sequence will eventually finish with a replacement build substrate 717a attached to one side of the container being located facing downwards.

The closure member 770 is removed from a position over the debuilding chamber aperture 704 and the retaining mechanism 716 is lowered to locate the replacement build substrate 717a on to the build platform 720. The closure mechanism 771 is driven such that the closure mechanism engages the releasing arms causing the replacement build substrate 717a to be released from the retaining mechanism 716. The retaining member 716 is then raised to provide clearance for the closure mechanism 771.

The build platform 720 is lowered such that the replacement build substrate 717a is flush or just sub-flush to a plane of an upper surface of the floor of the debuilding chamber 703. The closure mechanism 771 is then driven to close the debuilding chamber aperture 704 with the closure member 770. Again, this action will include the wiper moving over an upper surface of the replacement build substrate 717a to remove any powder therefrom.

The eventual position is shown in FIG. 13 with little or no gap between the replacement build substrate 717a and the closure member 770. In this way, little gas from the debuilding chamber is retained in the build chamber 718 after closing the debuilding chamber aperture 704. The build chamber 718 is then moved to the build position. Further lowering of the build platform 720 may be required to ensure that the replacement build substrate 717a clears plate 712. However, any gas drawn into the build chamber 718 by this movement will be gas from the transfer chamber.

Any oxygen that does become trapped within the build chamber 718 can be gettered before the next build commences. For example, one or more laser beams may be scanned across a surface of the replacement build substrate 717a before commencing the build to heat up and even melt the surface such that the oxygen reacts with the irradiated surface to be captured within the material of the replacement build substrate 717a.

Once the closure member 770 has been closed over the replacement build substrate 717a, the container may be rotated further to remove more powder from the object.

This sequence/further sequence of movements may be carried out for a period of time much longer than the time it took to insert the object and build substrate 717 into the retaining mechanism and locate the replacement build substrate 717a on to the build platform 719. The aim is for this sequence/further sequence of movements and removal of the object and build substrate 717 from the debuilding chamber 703 to be completed before the next object is ready to be inserted into the debuilding chamber 703 from the build chamber 718.

To remove the object and build substrate 717 from the debuilding chamber 703, a build substrate carrier (not shown) may be inserted into the debuilding chamber 703 below the retaining mechanism 716. The build substrate carrier may be integrated into the closure mechanism 771. The build substrate carrier is arranged to engage releasing arms 763 as is moves beneath the retaining mechanism 716 such that the build substrate 717 is released and comes to rest on the carrier. The carrier may comprise rollers or wheels that allow the build substrate with object attached to be removed from the debuilding chamber through a door without lifting. Once the build substrate with object attached has been removed from the debuilding chamber, a replacement build substrate 717a may be located on the carrier such that it can be picked up by the retaining mechanism 716 for placement on the build platform 720, as explained above.

It will be understood that alterations and modifications can be made to the above described embodiments without departing from the scope of the invention as defined herein. For example, removal of powder from the object in the debuilding chamber may be achieved without rotating the object. For example, an acceptable amount of powder removal may be achieved with gas jets and/or vibration of the object without rotation.

1-30. (canceled)

31. A powder bed fusion apparatus for building an object in a layer-by-layer manner, the powder bed fusion apparatus comprising a processing chamber having a processing chamber aperture; a scanner arranged to direct an energy beam to locations in a plane of the processing chamber aperture; a debuilding chamber having a debuilding chamber aperture; a build chamber defined by a build sleeve and a build platform movable within the build sleeve for supporting powder within the build sleeve, the build platform comprising a build platform seal for engaging with walls of the build sleeve to prevent the flow of powder past the build platform; at least one drive mechanism for driving movement of the build platform in the build sleeve; and a translation mechanism for moving the build chamber between a building position, in which the build sleeve aligns with the processing chamber aperture such that an energy beam can be delivered by the scanner to the processing chamber aperture to consolidate powder supported by the build platform in the build sleeve to build the object, and a debuilding position, in which the build sleeve aligns with the debuilding chamber aperture such that the object and powder can be inserted into the debuilding chamber through the debuilding chamber aperture through movement of the build platform within the build sleeve.

32. A powder bed fusion apparatus according to claim 31, comprising a closure member arranged to close the debuilding chamber aperture to powder flow.

33. A powder bed fusion apparatus according to claim 32, wherein the closure member is arranged to close the debuilding chamber aperture to prevent powder flow back into the build chamber, and/or into a space vacated by the build chamber when the build sleeve moves from the debuilding position.

34. A powder bed fusion apparatus according to claim 32, wherein a closure mechanism comprises a powder removal element for removing powder from an upper surface of the build platform as the closure member moves over the build platform.

35. A powder bed fusion apparatus according to claim 32, comprising a closure seal for sealing a gap between a debuilding chamber wall and the closure member when the closure member is in a position closing the debuilding chamber aperture.

36. A powder bed fusion apparatus according to claim 31, comprising a build substrate loader arranged to load a build substrate into the build sleeve after removal of the previous build substrate from the build sleeve.

37. A powder bed fusion apparatus according to claim 36, wherein the build substrate loader is arranged to load the build substrate into the build sleeve when the build sleeve is located in the debuilding position.

38. A powder bed fusion apparatus according to claim 31, comprising a retaining mechanism within the debuilding chamber arranged to receive a build substrate on which the object is built when the build substrate is inserted into the debuilding chamber and retain the build substrate in the debuilding chamber upon retraction of the drive mechanism.

39. A powder bed fusion apparatus according to claim 32, comprising a retaining mechanism within the debuilding chamber arranged to receive a build substrate on which the object is built when the build substrate is inserted into the debuilding chamber and to retain the build substrate and object clear of the debuilding chamber aperture such that the closure member is able to move to close the debuilding chamber aperture.

40. A powder bed fusion apparatus according to claim 31, wherein the build sleeve is arranged such that, in the building position, the build sleeve engages the processing chamber to surround the processing chamber aperture and, in the debuilding position, the build sleeve engages with the debuilding chamber to surround the debuilding chamber aperture.

41. A powder bed fusion apparatus according to claim 40, wherein the translation mechanism is arranged to displace the build chamber relative to the processing chamber and the debuilding chamber in a lateral direction to a reciprocating direction of the build platform in the build sleeve and the translation mechanism and/or the build sleeve is arranged such that, as the build chamber reaches the building position, at least a portion of the build sleeve is arranged to be displaced perpendicularly to the lateral direction to engage with a processing chamber wall.

42. A powder bed fusion apparatus according to claim 40, wherein the translation mechanism and/or the build sleeve is arranged such that, as the build chamber reaches the debuilding position, at least a portion of the build sleeve is arranged to be displaced perpendicularly to the lateral direction to engage with a debuilding chamber wall.

43. A powder bed fusion apparatus according to claim 31, wherein the drive mechanism is arranged to move with the build chamber from the building position to the debuilding position.

44. A powder bed fusion apparatus according to claim 31, wherein the drive mechanism is arranged to decouple from the build platform when the build chamber is translated from the building position to the debuilding position.

45. A powder bed fusion apparatus according to claim 31, comprising a gas circuit for forming an inert atmosphere in the processing chamber; an external door in the debuilding chamber for the exit of the object; and a hermetic closure for sealing an aperture between the external door and the processing chamber, or an inert gas trap for preventing the flow of air from the external door to the processing chamber.

46. A powder bed fusion apparatus according to claim 31 comprising a layer formation device for forming layers of powder in a working plane across a build volume delimited by the build chamber, when the build chamber is engaged with the processing chamber and a powder conveyor for conveying powder recovered from the debuilding chamber to the layer formation device.

47. A powder bed fusion method for building an object in a layer-by-layer manner, the powder bed fusion method comprising:—i) building an object in a build chamber, the build chamber defined by a build sleeve and a build platform movable within the build sleeve for supporting powder within the build sleeve, the build platform comprising a build platform seal for engaging with walls of the build sleeve to prevent the flow of powder past the build platform, wherein, the object is built with the build sleeve aligned with a processing chamber aperture of a processing chamber by directing an energy beam to selected locations within the processing chamber aperture to consolidate powder in the build chamber; ii) after completion of the build, moving the build chamber to align the build sleeve with a debuilding chamber aperture in a debuilding chamber and inserting the object and powder into the debuilding chamber from the build sleeve through the debuilding chamber aperture; and iii) disengaging the build sleeve from the debuilding chamber before or whilst separating powder from the object in the debuilding chamber.

48. A method according to claim 47, comprising closing the debuilding chamber aperture to powder flow with a closure member before or during disengagement of the build sleeve from the debuilding chamber.

49. A method according to claim 47, comprising repeating steps (i) through (iii).

50. A method according to claim 49, comprising separating the object from the powder in the debuilding chamber, at least in part, simultaneously with step (i).

51. A method according to claim 50, comprising forming an inert atmosphere in the debuilding chamber, separating the object from unconsolidated powder of the powder bed within the inert atmosphere in the debuilding chamber.

52. A method according to claim 51 comprising forming an inert atmosphere in the processing chamber and inserting the object and powder into the debuilding chamber when the debuilding chamber contains an inert atmosphere.

53. A method according to claim 52, comprising removing the object from the debuilding chamber after a debuilding process whilst maintaining the inert atmosphere in the processing chamber.

54. A method according to claim 47, comprising loading a build substrate into the build sleeve debuilding of the object in the debuilding chamber.

55. A method according to claim 47, comprising conveying the unconsolidated powder, separated from the object in the debuilding chamber, from the debuilding chamber to a powder dispenser for dispensing powder into the processing chamber.
